(19) United States
(12) Patent Application Publication
(10) Pub. No.: US 2024/0389110 A1
(43) Pub. Date: Nov. 21, 2024

(54) METHOD AND APPARATUS FOR DATA TRANSMISSION AND RECEPTION IN A WIRELESS COMMUNICATION SYSTEM

(71) Applicant: Samsung Electronics Co., Ltd., Suwon-si (KR)

(72) Inventors: Sungjin PARK, Suwon-si (KR); Hyunsuk RYU, Suwon-si (KR); Hyewon YANG, Suwon-si (KR); Junyung YI, Suwon-si (KR)

(21) Appl. No.: 18/663,448

(22) Filed: May 14, 2024

(30) Foreign Application Priority Data
May 15, 2023 (KR) 10-2023-0062622

(51) Int. Cl. H04W 72/232; H04L 1/1812; H04W 72/1268

(52) U.S. Cl. CPC H04W 72/232; H04L 1/1812; H04W 72/1268

(57) ABSTRACT

The disclosure relates to a 5G or 6G communication system for supporting a higher data transmission rate. A method performed by a user equipment (UE) in a wireless communication system is provided. The method includes receiving, from a base station, a high layer signaling including information enabling a multiplexing of a first hybrid automatic repeat request-acknowledgement (HARQ-ACK) information, receiving, from the base station, first downlink control information (DCI) scheduling physical uplink shared channel (PUSCH) repetitions, receiving, from the base station after the first DCI, second DCI indicating a physical uplink control channel (PUCCH), and transmitting, to the base station, the first HARQ-ACK information by multiplexing the first HARQ-ACK information in at least one PUSCH repetition other than a first PUSCH repetition among the PUSCH repetitions.

### CROSS-REFERENCE TO RELATED APPLICATION(S)

This application is based on and claims priority under 35 U.S.C. § 119 (a) of a Korean patent application number 10-2023-0062622, filed on May 15, 2023, in the Korean Intellectual Property Office, the disclosure of which is incorporated by reference herein in its entirety.

### BACKGROUND

### 1. Field

The disclosure relates to operations of a terminal and a base station in a wireless communication system. More particularly, the disclosure relates to a method for configuring and reporting data in a wireless communication system and a device capable of performing the same.

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHZ and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to smoothly provide these services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and a method capable of efficiently providing services in a mobile communication system.

Another aspect of the disclosure is to provide a method for configuring and reporting data in a wireless communication system and a device capable of performing the same according to an embodiment of the disclosure.

Another aspect of the disclosure is to provide a device and a method capable of efficiently providing services in a mobile communication system.

Additional aspects will be set forth in part in the description which follows and, in part, will be apparent from the description, or may be learned by practice of the presented embodiments.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a basic structure of a time-frequency domain in a wireless communication system according to an embodiment of the disclosure;

FIG. 2 is a diagram illustrating a structure of frames, subframes, and slots in a wireless communication system according to an embodiment of the disclosure;

FIG. 3 is a diagram illustrating physical uplink shared channel (PUSCH) repeated transmission type B in a wireless communication system according to an embodiment of the disclosure;

FIG. 4 shows diagrams illustrating an aperiodic channel state information (CSI) report method according to an embodiment of the disclosure;

FIGS. 5A, 5B, and 5C illustrate uplink control information being mapped to a physical uplink shared channel (PUSCH) according to various embodiments of the disclosure;

FIG. 6 is a diagram illustrating a procedure of transmitting and/or receiving uplink control information (UCI) information between a terminal and a base station via a PUSCH according to an embodiment of the disclosure;

FIG. 7 is a diagram illustrating a method of configuring a semi-static hybrid automatic repeat and request (HARQ)-acknowledgement (ACK) codebook (or Type-1 HARQ-ACK codebook) in a 5G communication system according to an embodiment of the disclosure;

FIG. 8 is a diagram illustrating a method of configuring a dynamic HARQ-ACK codebook (or Type-2 HARQ-ACK codebook) in a 5G communication system according to an embodiment of the disclosure;

FIG. 9 is a diagram illustrating a control and data information scheduling situation according to an embodiment of the disclosure;

FIG. 10 is a diagram illustrating a method of determining HARQ-ACK information according to an embodiment of the disclosure;

FIG. 11 is a flowchart illustrating a method of scheduling control and data information by a terminal according to an embodiment of the disclosure;

FIG. 12 is a diagram illustrating a structure of a UE in a wireless communication system according to an embodiment of the disclosure; and

FIG. 13 is a diagram illustrating a structure of a base station in a wireless communication system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments of the disclosure, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are provided with the same or corresponding reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined based on the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, long-term evolution (LTE) or LTE-advanced (LTE-A) systems may be described by way of example, but the embodiments of the disclosure may also be applied to other communication systems having similar technical backgrounds or channel types to the embodiments of the disclosure. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of third generation partnership project (3GPP), LTE (long-term evolution or evolved universal terrestrial radio access (E-UTRA)), LTE-advanced (LTE-A), LTE-Pro, high-rate packet data (HRPD) of 3GPP2, ultra-mobile broadband (UMB), institute of electrical and electronics engineers (IEEE) 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) or a mobile station (MS) transmits data or control signals to a base station (BS) or eNode B, and the downlink indicates a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a communication system subsequent to LTE, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services, such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time, such as 10 to 15 years because it is difficult to frequently replace the battery of the UE.

Lastly, URLLC is a cellular-based mission-critical wireless communication service. For example, URLLC may be used for services, such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also require a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

Hereinafter, embodiments of the disclosure will be described in detail in conjunction with the accompanying drawings. In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the following description, embodiments of the disclosure will be described in connection with 5G systems by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may also be applied to other communication systems through some modifications without significantly departing from the scope of the disclosure. The details of the disclosure may be employed in frequency division duplexing (FDD) and time division duplexing (TDD) systems.

Furthermore, in describing the disclosure, a detailed description of known functions or configurations incorporated herein will be omitted when it is determined that the description may make the subject matter of the disclosure unnecessarily unclear. The terms which will be described below are terms defined based on the functions in the disclosure, and may be different according to users, intentions of the users, or customs. Therefore, the definitions of the terms should be made based on the contents throughout the specification.

In the following description of the disclosure, upper layer signaling may refer to signaling corresponding to at least one signaling among the following signaling, or a combination of one or more thereof.
Master information block (MIB)
System information block (SIB) or SIB X (X=1, 2, . . . )
Radio resource control (RRC)
Medium access control (MAC) control element (CE)

In addition, L1 signaling may refer to signaling corresponding to at least one signaling method among signaling methods using the following physical layer channel or signaling, or a combination of one or more thereof.
Physical downlink control channel (PDCCH)
Downlink control information (DCI)
UE-specific DCI
Group common DCI
Common DCI

Scheduling DCI (for example, DCI used for the purpose of scheduling downlink or uplink data)

Non-scheduling DCI (for example, DCI not used for the purpose of scheduling downlink or uplink data)-Physical uplink control channel (PUCCH)
Uplink control information (UCI)

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through multiple embodiments of the disclosure, but they are not independent of each other, and one or more embodiments may be applied simultaneously or in combination.

### [NR Time-Frequency Resources]

Hereinafter, a frame structure of a 5G system will be described in more detail with reference to the accompanying drawings.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

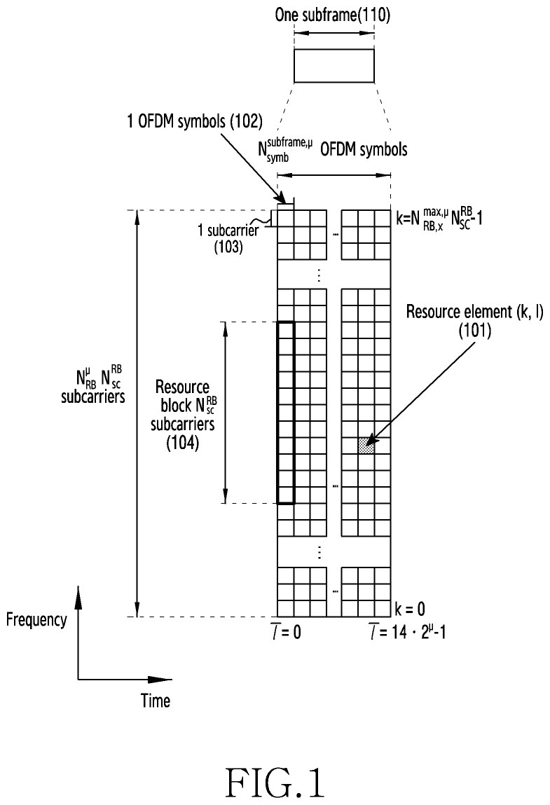

FIG. 1 illustrates a basic structure of a time-frequency domain in a wireless communication system according to an embodiment of the disclosure.

Referring to FIG. 1, a basic structure including one subframe 110 of a time-frequency domain, which is a radio resource domain used to transmit data or control channels in a 5G system, may be described.

In FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, NR_{SC}^{RB} (for example, 12) consecutive REs may constitute one resource block (RB) 104.

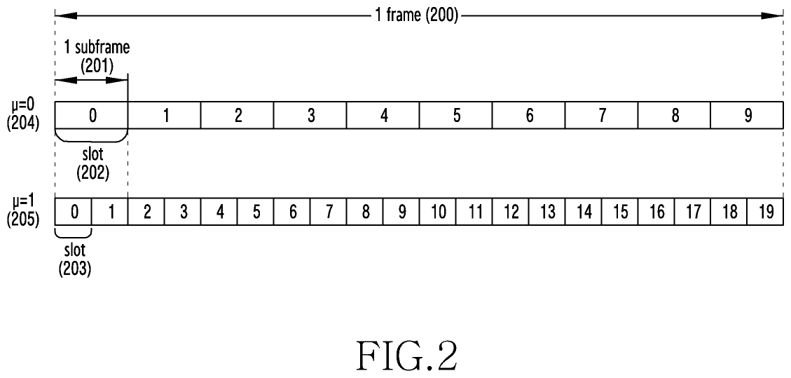

FIG. 2 illustrates a structure of frames, subframes, and slots in a wireless communication system according to an embodiment of the disclosure.

Referring to FIG. 2, FIG. 2 illustrates an example of the structure of one frame 200, a subframe 201, and a slot 202. One frame 200 may be defined as 10 ms. The subframe 201 may be defined as 1 ms. Therefore, one frame 200 may include a total of ten subframes 201. One slot 202 or 203 may be defined as 14 OFDM symbols (that is, the number of symbols per one slot Nₛₗₒₜ^{symb}=14). One subframe 201 may include one or multiple slots 202 and 203, and the number of slots 202 and 203 per one subframe 201 may vary depending on configuration values u for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. For example, the number of slots per one subframe Nₛₗₒₜ^{subframe,μ} may differ depending on the subcarrier spacing configuration value μ, and the number of slots per one frame Nₛₗₒₜ^{frame,μ} may differ accordingly. Nₛₗₒₜ^{subframe,μ} and Nₛₗₒₜ^{frame,μ} may be defined according to each subcarrier spacing configuration u as in Table 1 below.

TABLE 1

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [PDCCH: Regarding DCI]

Next, downlink control information (DCI) in a 5G system will be described in detail.

In a 5G system, scheduling information regarding uplink data (or physical uplink shared channel (PUSCH)) or downlink data (or physical downlink shared channel (PDSCH)) is transferred from a base station to a UE through DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH). A cyclic redundancy check is attached to the DCI message payload, and the CRC may be scrambled by a radio network temporary identifier (RNTI) corresponding to the identity of the UE. Different RNTIs may be used according to the purpose of the DCI message (for example, UE-specific data transmission, power control command, random access response, or the like). For example, the RNTI may be included in the CRC calculation process and then be transmitted, instead of being explicitly transmitted. Upon receiving a DCI message transmitted through the PDCCH, the UE may identify the CRC by using the allocated RNTI. If the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling the PUSCH, and the CRC may be scrambled by a C-RNTI. DCI format 0_0 in which the CRC is scrambled by a C-RNTI may include the following pieces of information, for example.

TABLE 2

| | |
|---|---|
| - | Identifier for DCI formats - [1] bit |
| - | Frequency domain resource assignment - |

[┌log₂(N_{RB}^{UL,BWP}(N_{RB}^{UL,BWP} + 1)/2)┐ ] bits

| | |
|---|---|
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | Transmit power control (TPC) command for scheduled PUSCH- |

[2] bits

| | |
|---|---|
| - | Uplink/supplementary uplink indicator (UL/SUL indicator) - 0 |

or 1 bit

DCI format 0_1 may be used as non-fallback DCI for scheduling the PUSCH, and the CRC may be scrambled by a C-RNTI. DCI format 0_1 in which the CRC is scrambled by a C-RNTI may include the following pieces of information, for example.

```
TABLE 3
  Carrier indicator-0 or 3 bits
  UL/SUL indicator-0 or 1 bit
  Identifier for DCI formats-[1] bits
  Bandwidth part indicator-0, 1 or 2 bits
  Frequency domain resource assignment
    For resource allocation type 0, ┌N_{RB}^{UL,BWP}/P┐ bits
    For resource allocation type 1, ┌log₂(N_{RB}^{UL,BWP}(N_{RB}^{UL,BWP} +
    1)/2)┐ bits
  Time domain resource assignment-1, 2, 3, or 4 bits
  virtual resource block-to-physical resource block (VRB-to-PRB)
mapping-0 or 1 bit, only for resource allocation type 1.
    0 bit if only resource allocation type 0 is configured;
    1 bit otherwise.
  Frequency hopping flag-0 or 1 bit, only for resource allocation type 1.
    0 bit if only resource allocation type 0 is configured;
    1 bit otherwise.
  Modulation and coding scheme-5 bits
  New data indicator-1 bit
  Redundancy version-2 bits
  HARQ process number-4 bits
  1st downlink assignment index-1 or 2 bits
    1 bit for semi-static HARQ-ACK codebook;
    2 bits for dynamic HARQ-ACK codebook with single
    HARQ-ACK codebook.
  2nd downlink assignment index-0 or 2 bits
    2 bits for dynamic HARQ-ACK codebook with two HARQ-
    ACK sub-codebooks;
    0 bit otherwise.
  TPC command for scheduled PUSCH-2 bits
  Sounding reference signal (SRS) resource indicator-
```

| | |
|---|---|
| $⌈ {log}_{2} ( {\sum }_{k = 1}^{{L}_{max} \sum } ( \begin{matrix}{N}_{SRS} \\ k\end{matrix} ) 0 ) ⌉$ | or ┌log₂( [symbol] )┐ bits |

```
    $⌈ {log}_{2} ( {\sum }_{k = 1}^{{L}_{max} \sum } ( \begin{matrix}{N}_{SRS} \\ k\end{matrix} ) 0 ) ⌉ bits for non - codebook based$
    PUSCH transmission;
    ┌log₂(N_{SRS})┐ bits for codebook based PUSCH transmission.
  Precoding information and number of layers-up to 6 bits
  Antenna ports-up to 5 bits
  SRS request-2 bits
  CSI request-0, 1, 2, 3, 4, 5, or 6 bits
  Code block group (CBG) transmission information-0, 2, 4, 6, or 8 bits
  Phase tracking reference signal (PTRS)-demodulation reference
signal (DMRS) association-0 or 2 bits.
  beta_offset indicator0 or 2 bits
  DMRS sequence initialization-0 or 1 bit
```

DCI format 1_0 may be used as fallback DCI for scheduling the PDSCH, and the CRC may be scrambled by a C-RNTI. DCI format 1_0 in which the CRC is scrambled by a C-RNTI may include the following pieces of information, for example.

TABLE 4

| | |
|---|---|
| - | Identifier for DCI formats - [1] bit |
| - | Frequency domain resource assignment - |

[┌log₂(N_{RB}^{DL,BWP}(N_{RB}^{DL,BWP} + 1)/2)┐ ] bits

| | |
|---|---|
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | Physical uplink control channel (PUCCH) resource indicator- 3 bits |
| - | PDSCH-to-HARQ feedback timing indicator- [3] bits |

DCI format 1_1 may be used as non-fallback DCI for scheduling the PDSCH, and the CRC may be scrambled by a C-RNTI. DCI format 1_1 in which the CRC is scrambled by a C-RNTI may include the following pieces of information, for example.

TABLE 5

| - | Carrier indicator - 0 or 3 bits | |
|---|---|---|
| - | Identifier for DCI formats - [1] bits | |
| - | Bandwidth part indicator - 0, 1 or 2 bits | |
| - | Frequency domain resource assignment | |
| | • | For resource allocation type 0, ┌N_{RB}^{DL,BWP}/P┐ bits |
| | • | For resource allocation type 1, ┌log₂(N_{RB}^{UL,BWP} |
| | | (N_{RB}^{DL,BWP} + 1)/2)┐ bits |

| | |
|---|---|
| - | Time domain resource assignment -1, 2, 3, or 4 bits |
| - | VRB-to-PRB mapping - 0 or 1 bit, only for resource |

allocation type 1.

| | |
|---|---|
| • | 0 bit if only resource allocation type 0 is configured; |
| • | 1 bit otherwise. |

| | |
|---|---|
| - | PRB bundling size indicator - 0 or 1 bit |
| - | Rate matching indicator - 0, 1, or 2 bits |
| - | ZP CSI-RS trigger - 0, 1, or 2 bits |

For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication- 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

### [PDSCH: Processing Time]

Next, a PDSCH processing time (PDSCH processing procedure time) will be described. When the base station schedules the UE to transmit a PDSCH by using DCI format 1_0, 1_1 or 1_2, the UE may need a PDSCH processing time for receiving a PDSCH by applying a transmission method (for example, modulation/demodulation and coding indication index (MCS), demodulation reference signal-related information, time and frequency resource allocation information, and the like) indicated through DCI. Based on this, the PDSCH processing time has been defined in the 5G communication system. The PDSCH processing time of the UE may follow Equation 1 given below

$$Tproc , 1 = ( N 1 + d 1 , 1 + d 2 ) ( 2048 + 144 ) κ 2 - μ Tc + Text \qquad Equation 1$$

Each parameter in Tproc,1 described above in Equation 3 may have the following meaning.
N1: the number of symbols determined according to UE processing capability 1 or 2 based on the UE's capability and numerology u. N1 may have a value in Table 6 if UE processing capability 1 is reported according to the UE's capability report, and may have a value in Table 7 if UE processing capability 2 is reported, and if availability of UE processing capability 2 is configured through upper layer signaling. The numerology u may correspond to the minimum value among μPDCCH, μPDSCH, μUL so as to maximize Tproc,1, and μPDCCH, μPDSCH, μUL may refer to the numerology of a PDCCH that scheduled a PDSCH, the numerology of the scheduled PDSCH, and numerology of an uplink channel in which a HARQ-ACK is to be transmitted. Table 6 may include information on the PDSCH processing time in the case of PDSCH processing capability 1.

TABLE 6

| | PDSCH decoding time N₁ [symbols] | |
|---|---|---|
| | | If PDSCH mapping type A and |
| | If PDSCH mapping type A and | B both do not correspond to |
| | B both correspond to dmrs- | dmrs-AdditionalPosition = pos0 |
| | AdditionalPosition = pos0 | inside DMRS-Downlink Config |
| | inside DMRS- | which is upper layer signaling, |
| | DownlinkConfig which is | or if no upper layer parameter is |
| μ | upper layer signaling | configured |
| 0 | 8 | N_{1,0} |
| 1 | 10 | 13 |
| 2 | 17 | 20 |
| 3 | 20 | 24 |

Table 7 may include information on the PDSCH processing time in the case of PDSCH processing capability 2.

TABLE 7

| | PDSCH decoding time N₁ [symbols] |
|---|---|
| | If PDSCH mapping type A and B both correspond to dmrs- |
| | AdditionalPosition = pos0 inside DMRS-DownlinkConfig |
| μ | which is upper layer signaling |
| 0 | 3 |
| 1 | 4.5 |
| 2 | 9 for frequency range 1 |

κ: 64
Text: if the UE uses a shared spectrum channel access scheme, the UE may calculate Text and apply the same to the PDSCH processing time. Otherwise, Text is assumed to be 0.
If 11 which represents the PDSCH DMRS location value is 12, N1,0 in Table 6 above has the value of 14, and otherwise has the value of 13.
With regard to PDSCH mapping type A, if the last symbol of the PDSCH is the i^{th} symbol in the slot in which the PDSCH is transmitted, and if i<7, d1,1 is then 7-i, and d1,1 is otherwise 0.
d2: if a PUCCH having a high priority index temporally overlaps another PUCCH or a PUSCH having a low priority index, d2 of the PUCCH having a high priority index may be configured as a value reported from the UE. Otherwise, d2 is 0.
If PDSCH mapping type B is used with regard to UE processing capability 1, the d1,1 value may be determined by the number (L) of symbols of a scheduled PDSCH and the number of overlapping symbols between the PDCCH that schedules the PDSCH and the scheduled PDSCH, as follows.
If L≥7, then d1, 1=0.
If −L≥4 and L≤6, then d1, 1=7−L.
If L=3, then d1,1=min (d, 1).
If L=2, then d1, 1=3+d.
If PDSCH mapping type B is used with regard to UE processing capability 2, the d1,1 value may be determined by the number (L) of symbols of a scheduled PDSCH and the number of overlapping symbols between the PDCCH that schedules the PDSCH and the scheduled PDSCH, as follows
If L≥7, then d1, 1=0.
If −L≥4 and L≤6, then d1, 1=7−L.
If L=2,
If the scheduling PDCCH exists inside a CORESET including three symbols, and if the CORESET and the scheduled PDSCH have the same start symbol, then d1,1=3.
Otherwise, d1,1=d.
In the case of a UE supporting capability 2 inside a given serving cell, the PDSCH processing time based on UE processing capability 2 may be applied by the UE if processing Type2Enabled (upper layer signaling) is configured as “enable” with regard to the corresponding cell.

If the location of the first uplink transmission symbol of a PUCCH including HARQ-ACK information (in connection with the corresponding location, K1 defined as the HARQ-ACK transmission timepoint, a PUCCH resource used to transmit the HARQ-ACK, and the timing advance effect may be considered) does not start earlier than the first uplink transmission symbol that comes after the last symbol of the PDSCH over a time of Tproc,1, the UE needs to transmit a valid HARQ-ACK message. For example, the UE needs to transmit a PUCCH including a HARQ-ACK only if the PDSCH processing time is sufficient. The UE cannot otherwise provide the base station with valid HARQ-ACK information corresponding to the scheduled PDSCH. The T-proc,1 may be used in the case of either a normal or an expanded CP. In the case of a PDSCH having two PDSCH transmission locations configured inside one slot, d1,1 is calculated with reference to the first PDSCH transmission location inside the corresponding slot.

### [PDSCH: Reception Preparation Time During Cross-Carrier Scheduling]

Next, in the case of cross-carrier scheduling in which the numerology (μPDCCH) by which a scheduling PDCCH is transmitted and the numerology (μPDSCH) by which a PDSCH scheduled by the corresponding PDCCH is transmitted are different from each other, the PDSCH reception reparation time (Npdsch) of the UE defined with regard to the time interval between the PDCCH and PDSCH will be described.

If μPDCCH<μPDSCH, the scheduled PDSCH cannot be transmitted before the first symbol of the slot coming after Npdsch symbols from the last symbol of the PDCCH that scheduled the corresponding PDSCH. The transmission symbol of the scheduled PDSCH may include a DM-RS.

If μPDCCH>μPDSCH, the scheduled PDSCH may be transmitted after Npdsch symbols from the last symbol of the PDCCH that scheduled the corresponding PDSCH. The transmission symbol of the scheduled PDSCH may include a DM-RS. In Table 8, Npdsch according to scheduled PDCCH subcarrier spacings may have at least one of values in Table 8 below.

TABLE 8

| μ_{PDCCH} | N_{pdsch} [symbols] |
|---|---|
| 0 | 4 |
| 1 | 5 |
| 2 | 10 |
| 3 | 14 |

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission can be made by DCI format 0_0 or 0_1.

Configured grant Type 1 PUSCH transmission may be configured semi-statically by receiving configuredGrantConfig including rrc-ConfiguredUplinkGrant in Table 9 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 9 through upper signaling. If PUSCH transmission is operated by a configured grant, parameters applied to the PUSCH transmission may be applied through configuredGrantConfig (upper signaling) in Table 9 except for dataScramblingIdentityPUSCH, txConfig, codebookSubset, maxRank, and scaling of UCI-OnPUSCH, which are provided by pusch-Config in Table 10, which is upper signaling. If provided with transformPrecoder inside configuredGrantConfig (upper signaling) in Table 14, the UE may apply tp-pi2BPSK inside pusch-Config in Table 15 to PUSCH transmission operated by a configured grant.

TABLE 9

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, |
| qam64LowSE} | OPTIONAL, -- Need S |
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, |

sym5x14, sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14,

sym2560x14, sym5120x14,

sym6, sym1x12, sym2x12, sym4x12, sym5x12,

sym8x12, sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |
| OPTIONAL, -- Need R | |
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks-1) | OPTIONAL, -- Need R |
| pathlossReferenceIndex | INTEGER (0..maxNrofPUSCH- |

```
PathlossReferenceRSs-1),
    ...
  }
OPTIONAL, -- Need R
  ...
}
```

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 10, which is upper signaling, is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE may perform beam configuration for PUSCH transmission by using pucch-spatialRelationInfoID corresponding to a UE-specific PUCCH resource corresponding to the minimum ID inside an activated uplink BWP inside a serving cell, and the PUSCH transmission may be based on a single antenna port. The UE may not expect scheduling regarding PUSCH transmission through DCI format 0_0 inside a BWP having no configured PUCCH resource including pucch-spatialRelationInfo. If the UE has no configured txConfig inside pusch-Config in Table 10, the UE may not expect scheduling through DCI format 0_1.

TABLE 10

| | |
|---|---|
| PUSCH-Config ::= | SEQUENCE { |
| dataScramblingIdentityPUSCH | INTEGER (0..1023) |

| | |
|---|---|
| | OPTIONAL, -- Need S |
| txConfig | ENUMERATED {codebook, nonCodebook} |
| | OPTIONAL, -- Need S |

| | |
|---|---|
| dmrs-UplinkForPUSCH-MappingTypeA | SetupRelease { DMRS- |
| UplinkConfig } | OPTIONAL, -- Need M |
| dmrs-UplinkForPUSCH-MappingTypeB | SetupRelease { DMRS- |
| UplinkConfig } | OPTIONAL, -- Need M |
| pusch-PowerControl | PUSCH-PowerControl |

| | |
|---|---|
| | OPTIONAL, -- Need M |
| frequencyHopping | ENUMERATED {intraSlot, interSlot} |
| | OPTIONAL, -- Need S |
| frequencyHoppingOffsetLists | SEQUENCE (SIZE (1..4)) OF INTEGER |

(1..maxNrofPhysicalResourceBlocks-1)

| | |
|---|---|
| | OPTIONAL, -- Need M |
| resourceAllocation | ENUMERATED { resourceAllocationType0, |

resourceAllocationType1, dynamicSwitch},

| pusch-TimeDomainAllocationList | | SetupRelease { PUSCH- |
|---|---|---|
| TimeDomainResourceAllocationList } | | OPTIONAL, -- Need M |
| pusch-AggregationFactor | ENUMERATED { n2, n4, n8 } | |
| | OPTIONAL, -- Need S | |
| mcs-Table | ENUMERATED {qam256, qam64LowSE} | |
| | OPTIONAL, -- Need S | |
| mcs-TableTransformPrecoder | | ENUMERATED {qam256, |
| qam64LowSE} | | OPTIONAL, -- Need S |

| | |
|---|---|
| transformPrecoder | ENUMERATED {enabled, disabled} |
| | OPTIONAL, -- Need S |

| | |
|---|---|
| codebookSubset | ENUMERATED |

```
  {fullyAndPartialAndNonCoherent, partialAndNonCoherent,nonCoherent}
                          OPTIONAL, -- Cond codebookBased
```

| | |
|---|---|
| maxRank | INTEGER (1..4) |

OPTIONAL, -- Cond codebookBased

| | |
|---|---|
| rbg-Size | ENUMERATED { config2} |
| | OPTIONAL, -- Need S |
| uci-OnPUSCH | SetupRelease { UCI-OnPUSCH} |
| | OPTIONAL, -- Need M |
| tp-pi2BPSK | ENUMERATED {enabled} |
| | OPTIONAL, -- Need S |
| | ... |
| | } |

The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE may determine a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE may have at least one SRS resource configured therefor, and may have a maximum of two SRS resources configured therefor. If the UE is provided with an SRI through DCI, the SRS resource indicated by the SRI may refer to the SRS resource corresponding to the SRI among SRS resources transmitted prior to the PDCCH including the SRI. In addition, the TPMI and the transmission rank may be given through “precoding information and number of layers” (a field inside DCI) or configured through precodingAndNumberOfLayers (upper signaling). The TPMI may be used to indicate a precoder applied to PUSCH transmission. If one SRS resource is configured for the UE, the TPMI may be used to indicate a precoder to be applied in the configured SRS resource. If multiple SRS resources are configured for the UE, the TPMI may be used to indicate a precoder to be applied in an SRS resource indicated through the SRI.

The precoder to be used for PUSCH transmission may be selected from an uplink codebook having the same number of antenna ports as the value of nrofSRS-Ports inside SRS-Config (upper signaling). In connection with codebook-based PUSCH transmission, the UE may determine a codebook subset, based on codebookSubset inside pusch-Config (upper signaling) and TPMI. The codebook Subset inside pusch-Config (upper signaling) may be configured to be one of “fullyAndPartialAndNonCoherent”, “partialAndNonCoherent”, or “noncoherent”, based on UE capability reported by the UE to the base station. If the UE reported “partialAndNonCoherent” as UE capability, the UE may not expect that the value of codebook Subset (upper signaling) will be configured as “fully AndPartialAndNonCoherent”. In addition, if the UE reported “nonCoherent” as UE capability, UE may not expect that the value of codebookSubset (upper signaling) will be configured as “fully AndPartialAndNonCoherent” or “partialAndNonCoherent”. If nrofSRS-Ports inside SRS-ResourceSet (upper signaling) indicates two SRS antenna ports, UE may not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the SRS resource set. If multiple SRS resources are configured inside the SRS resource set wherein the value of usage inside SRS-ResourceSet (upper signaling) is “codebook”, the UE may expect that the value of nrofSRS-Ports inside SRS-Resource (upper signaling) is identical for all SRS resources.

The UE may transmit, to the base station, one or multiple SRS resources included in the SRS resource set wherein the value of usage is configured as “codebook” according to upper signaling, and the base station may select one from the SRS resources transmitted by the UE and instructs the UE to transmit a PUSCH by using transmission beam information of the corresponding SRS resource. In connection with the codebook-based PUSCH transmission, the SRI may be used as information for selecting the index of one SRS resource, and may be included in DCI. Additionally, the base station may add information indicating the rank and TPMI to be used by the UE for PUSCH transmission to the DCI. Using the SRS resource indicated by the SRI, the UE may apply the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE may not expect that information regarding the precoder for SRS transmission will be updated.

If the configured value of resourceType inside SRS-ResourceSet (upper signaling) is “aperiodic”, the connected NZP CSI-RS may be indicated by an SRS request which is a field inside DCI format 0_1 or 1_1. If the connected NZP CSI-RS resource is an aperiodic NZP CSI-RS resource, the existence of the connected NZP CSI-RS may be indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS may be positioned in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE may not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI may refer to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE may occupy the same RB. The UE may configure one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the base station, one or multiple SRS resources inside the SRS resource set wherein the configured usage is “nonCodebook”, and the base station may select one or multiple SRS resources from the received one or multiple SRS resources. In connection with the non-codebook-based PUSCH transmission, the SRI may indicate an index that may express one SRS resource or a combination of multiple SRS resources, and the SRI may be included in DCI. The number of SRS resources indicated by the SRI transmitted by the base station may be the number of transmission layers of the PUSCH, and the UE may transmit the PUSCH by applying the precoder applied to SRS resource transmission to each layer.

### [PUSCH: Preparation Procedure Time]

Next, a PUSCH preparation procedure time will be described. If a base station schedules a UE so as to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. Accordingly, the PUSCH preparation procedure time is defined in the 5G communication system. The PUSCH preparation procedure time of the UE may follow Equation 2 given below.

$$Tproc , 2 = \qquad Equation 2$$

$$max ( ( N 2 + d 2 , 1 + d 2 ) ( 2048 + 144 ) κ 2 - μ Tc + Text + Tswitch , d 2 , 2 )$$

Each parameter in Tproc,2 described above in Equation 4 may have the following meaning.
N2: the number of symbols determined according to UE processing capability 1 or 2, based on the UE's capability, and numerology μ. N2 may have a value in Table 11 if UE processing capability 1 is reported according to the UE's capability report, and may have a value in Table 12 if UE processing capability 2 is reported, and if availability of UE processing capability 2 is configured through upper layer signaling.

TABLE 11

| | PUSCH preparation time N₂ |
|---|---|
| μ | [symbols] |
| 0 | 10 |
| 1 | 12 |
| 2 | 23 |
| 3 | 36 |

TABLE 12

| | PUSCH preparation time N₂ |
|---|---|
| μ | [symbols] |
| 0 | 5 |
| 1 | 5.5 |
| 2 | 11 for frequency range 1 |

d2,1: the number of symbols determined to be 0 if all resource elements of the first OFDM symbol of PUSCH transmission include DM-RSs, and to be 1 otherwise.
κ: 64
μ: follows a value, among μ_{DL} and μ_{UL}, which makes Tproc,2 larger. μ_{DL} L refers to the numerology of a downlink used to transmit a PDCCH including DCI that schedules a PUSCH, and μ_{UL} refers to the numerology of an uplink used to transmit a PUSCH.
Tc: has 1/Δfₘₐₓ·N_{f}, Δfₘₐₓ=480·10³ Hz, N_{f}=4096
d2,2: follows a BWP switching time if DCI that schedules a PUSCH indicates BWP switching, and has 0 otherwise.
d2: if OFDM symbols overlap temporally between a PUSCH having a high priority index and a PUCCH having a low priority index, the d2 value of the PUSCH having a high priority index is used. Otherwise, d2 is 0.
Text: if the UE uses a shared spectrum channel access scheme, the UE may calculate Text and apply the same to a PUSCH preparation procedure time. Otherwise, Text is assumed to be 0.
Tswitch: if an uplink switching spacing has been triggered, Tswitch is assumed to be the switching spacing time. Otherwise, Tswitch is assumed to be 0.

The base station and the UE may determine that the PUSCH preparation procedure time is insufficient if the first symbol of a PUSCH starts earlier than the first uplink symbol in which a CP starts after Tproc,2 from the last symbol of a PDCCH including DCI that schedules the PUSCH, in view of the influence of timing advance between the uplink and the downlink and time domain resource mapping information of the PUSCH scheduled through the DCI. Otherwise, the base station and the UE may determine that the PUSCH preparation procedure time is sufficient. The UE may transmit the PUSCH only if the PUSCH preparation procedure time is sufficient, and may ignore the DCI that schedules the PUSCH if the PUSCH preparation procedure time is insufficient.

### [PUSCH: Regarding Repeated Transmission]

Hereinafter, repeated transmission of an uplink data channel in a 5G system will be described in detail. A 5G system may support two types of methods for repeatedly transmitting an uplink data channel, PUSCH repeated transmission type A and PUSCH repeated transmission type B. One of PUSCH repeated transmission type A and type B may be configured for a UE through upper layer signaling.

PUSCH repeated transmission type A
As described above, the symbol length of an uplink data channel and the location of the start symbol may be determined by a time domain resource allocation method in one slot, and a base station may notify a UE of the number of repeated transmissions through upper layer signaling (for example, RRC signaling) or L1 signaling (for example, DCI).
Based on the number of repeated transmissions received from the base station, the UE may repeatedly transmit an uplink data channel having the same length and start symbol as the configured uplink data channel, in a continuous slot. If the base station configured a slot as a downlink for the UE, or if at least one of symbols of the uplink data channel configured for the UE is configured as a downlink, the UE may omit uplink data channel transmission, but may count the number of repeated transmissions of the uplink data channel.

PUSCH repeated transmission type B
As described above, the start symbol and length of an uplink data channel may be determined by a time domain resource allocation method in one slot, and the base station may notify the UE of the number of repeated transmissions (numberofrepetitions) through upper layer signaling (for example, RRC signaling) or L1 signaling (for example, DCI).
The nominal repetition of the uplink data channel is determined as follows, based on the previously configured start symbol and length of the uplink data channel. The slot in which the nth nominal repetition starts is given by

$${K}_{s} + ⌊ \frac{S + n \cdot L}{{N}_{s y m b}^{s l o t}} ⌋ ,$$

and the symbol starting in that slot is given by mod (S+n·L,N_{symb}^{slot}). The slot in and the symbol which the nth nominal repetition ends is given by

$${K}_{s} + ⌊ \frac{S + ( n + 1 ) \cdot L - 1}{{N}_{s y m b}^{s l o t}} ⌋ ,$$

ending in that slot is given by mod (S+(n+1)·L−1, N_{symb}^{slot}). In this regard, n=0, . . . , numberofrepetitions-1, S may refer to the start symbol of the configured uplink data channel, and L may refer to the symbol length of the configured uplink data channel. Kₛ refers to the slot in which PUSCH transmission starts, and N_{symb}^{slot} refers to the number of symbols per slot.
The UE may determine an invalid symbol for PUSCH repeated transmission type B. A symbol configured as a downlink by tdd-UL-DL-ConfigurationCommon or tdd-UL-DL-ConfigurationDedicated may be determined as the invalid symbol for PUSCH repeated transmission type B. Additionally, the invalid symbol may be configured in an upper layer parameter (for example, InvalidSymbolPattern). The upper layer parameter (for example, InvalidSymbolPattern) may provide a symbol level bitmap across one or two slots, thereby configuring the invalid symbol. In the bitmap, 1 may represent the invalid symbol. Additionally, the cycle and pattern of the bitmap may be configured through the upper layer parameter (for example, InvalidSymbolPattern). If an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 indicates 1, the UE may apply an invalid symbol pattern, and if the above parameter indicates 0, the UE may not apply the invalid symbol pattern. If an upper layer parameter (for example, InvalidSymbolPattern) is configured, and if InvalidSymbolPatternIndicator-ForDCIFormat0_1 or parameter InvalidSymbolPatternIndicator-ForDCIFormat0_2 is not configured, the UE may apply the invalid symbol pattern.

After an invalid symbol is determined, the UE may consider, with regard to each nominal repetition, that symbols other than the invalid symbol are valid symbols. If one or more valid symbols are included in each nominal repetition, the nominal repetition may include one or more actual repetitions. Each actual repetition includes a set of consecutive valid symbols available for PUSCH repeated transmission type B in one slot.

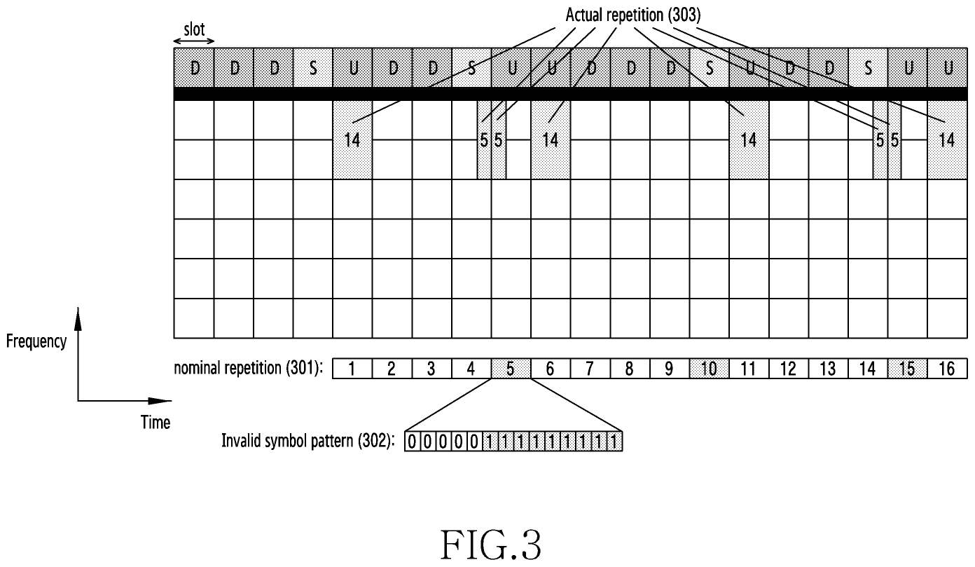

FIG. 3 illustrates PUSCH repeated transmission type B in a wireless communication system according to an embodiment of the disclosure.

Referring to FIG. 3, the UE may receive the following configurations: the start symbol S of an uplink data channel is 0, the length L of the uplink data channel is 14, and the number of repeated transmissions is 16. In this case, nominal repetitions may appear in 16 consecutive slots (301). Thereafter, the UE may determine that the symbol configured as a downlink symbol in each nominal repetition 301 is an invalid symbol. In addition, the UE may determine that symbols configured as 1 in the invalid symbol pattern 302 are invalid symbols. If valid symbols other than invalid symbols in respective nominal repetitions constitute one or more consecutive symbols in one slot, they may be configured and transmitted as actual repetitions (303).

In addition, with regard to PUSCH repeated transmission, additional methods may be defined in NR Release 16 with regard to UL grant-based PUSCH transmission and configured grant-based PUSCH transmission, across slot boundaries, as follows:
Method 1 (mini-slot level repetition): through one UL grant, two or more PUSCH repeated transmissions may be scheduled inside one slot or across the boundary of consecutive slots. In addition, in connection with method 1, time domain resource allocation information inside DCI may indicate resources of the first repeated transmission. In addition, time domain resource information of remaining repeated transmissions may be determined according to time domain resource information of the first repeated transmission, and the uplink or downlink direction determined with regard to each symbol of each slot. Each repeated transmission may occupy consecutive symbols.
Method 2 (multi-segment transmission): through one UL grant, two or more PUSCH repeated transmissions may be scheduled in consecutive slots. Transmission no. 1 may be designated with regard to each slot, and the start point or repetition length may differ between respective transmission. In addition, in method 2, time domain resource allocation information inside DCI may indicate the start point and repetition length of all repeated transmissions. In addition, when performing repeated transmissions inside a single slot through method 2, if there may be multiple bundles of consecutive uplink symbols in the corresponding slot, respective repeated transmissions may be performed with regard to respective uplink symbol bundles. If there is a single bundle of consecutive uplink symbols in the corresponding slot, PUSCH repeated transmission may be performed once according to the method of NR Release 15.
Method 3: two or more PUSCH repeated transmissions may be scheduled in consecutive slots through two or more UL grants. Transmission no. 1 may be designated with regard to each slot, and the nth UL grant may be received before PUSCH transmission scheduled by the (n−1)th UL grant is over.
Method 4: through one UL grant or one configured grant, one or multiple PUSCH repeated transmissions inside a single slot, or two or more PUSCH repeated transmissions across the boundary of consecutive slots may be supported. The number of repetitions indicated to the UE by the base station is only a nominal value, and the UE may actually perform a larger number of PUSCH repeated transmissions than the nominal number of repetitions. Time domain resource allocation information inside DCI or configured grant may refer to resources of the first repeated transmission indicated by the base station. Time domain resource information of remaining repeated transmissions may be determined with reference to resource information of the first repeated transmission and the uplink or downlink direction of symbols. If time domain resource information of a repeated transmission indicated by the base station spans a slot boundary or includes an uplink/downlink switching point, the corresponding repeated transmission may be divided into multiple repeated transmissions. One repeated transmission may be included in one slot with regard to each uplink period.

### [PUSCH: Frequency Hopping Process]

Hereinafter, frequency hopping of a physical uplink shared channel (PUSCH) in a 5G communication system will be described in detail.

A 5G communication system may support two kinds of PUSCH frequency hopping methods with regard to each PUSCH repeated transmission type. First of all, in PUSCH repeated transmission type A, intra-slot frequency hopping and inter-slot frequency hopping may be supported, and in PUSCH repeated transmission type B, inter-repetition frequency hopping and inter-slot frequency hopping may be supported.

The inter-slot frequency hopping method supported in PUSCH repeated transmission type A may be a method in which a UE transmits allocated resources in the frequency domain, after changing the same by a configured frequency offset, by two hops in one slot. The start RB of each hop in connection with intra-slot frequency hopping may be expressed by Equation 3 below:

$$R {B}_{s t a r t} = \{ \begin{matrix}R {B}_{s t a r t} & i = 0 \\ ( R {B}_{s t a r t} + R {B}_{offset} ) mod {N}_{B W P}^{s i z e} & i = 1\end{matrix} \qquad Equation 3$$

In Equation 3, i=0 and i=1 may indicate the first and second hops, respectively, and RBₛₜₐᵣₜ may represent the start RB in a UL BWP and may be calculated from a frequency resource allocation method. RB_{offset} may indicate a frequency offset between two hops through an upper layer parameter. The number of symbols of the first hop may be represented by N_{symb}^{PUSCH,S}/2, and number of symbols of the second hop may be represented by N_{symb}^{PUSCH,s}−N_{symb}^{PUSCH,s}/2. N_{symb}^{PUSCH,s} may represent the number of OFDM symbols, which corresponds to the length of PUSCH transmission in one slot.

Next, the inter-slot frequency hopping method supported in PUSCH repeated transmission types A and B may be a method in which the UE transmits allocated resources in the frequency domain, after changing the same by a configured frequency offset, in each slot. The start RB during ng slots in connection with inter-slot frequency hopping may be expressed by Equation 4 below. Equation 4

$$R {B}_{s t a r t} ( {n}_{s}^{μ} ) = \{ \begin{matrix}R {B}_{s t a r t} & {n}_{s}^{μ} mod 2 = 0 \\ ( R {B}_{s t a r t} + R {B}_{offset} ) mod {N}_{B W P}^{s i z e} & {n}_{s}^{μ} mod 2 = 1\end{matrix} In \qquad Equation 4$$

Equation 4, nₛ^{μ} may refer to the current slot number during multi-slot PUSCH transmission, and RBₛₜₐᵣₜ refers to the start RB inside a UL BWP and may be calculated from a frequency resource allocation method. RB_{offset} may refer to a frequency offset between two hops through an upper layer parameter.

Next, the inter-repetition frequency hopping method supported in PUSCH repeated transmission type B may be a method in which resources allocated in the frequency domain regarding one or multiple actual repetitions in each nominal repetition are moved by a configured frequency offset and then transmitted. The index RBₛₜₐᵣₜ(n) of the start RB in the frequency domain regarding one or multiple actual repetitions in the nth nominal repetition may follow Equation 5 given below.

$$R {B}_{s t a r t} ( n ) = \{ \begin{matrix}R {B}_{s t a r t} & n mod 2 = 0 \\ ( R {B}_{s t a r t} + R {B}_{offset} ) mod {N}_{B W P}^{s i z e} & n mod 2 = 1\end{matrix} \qquad Equation 5$$

In Equation 5, n may refer to the index of nominal repetition, and RB_{offset} may refer to an RB offset between two hops through an upper layer parameter. [PUSCH: Multiplexing rules during AP/SP CSI reporting]

Hereinafter, a method of measuring and reporting a channel state in the 5G communication system will be described in detail. Channel state information (CSI) may include a channel quality indicator (channel quality information (CQI)), a precoding matrix index (precoding matrix indicator (PMI)), a CSI-RS resource indicator (CRI), an SS/PBCH block resource indicator (SSBRI), a layer indicator (LI), a rank indicator (RI), a reference signal received power (L1-RSRP), and/or the like. A base station may control time and frequency resources for the aforementioned CSI measurement and report of a terminal.

For the aforementioned CSI measurement and report, the terminal may be configured, via higher-layer signaling, with setting information for N (N>1) CSI reports (CSI-ReportConfig), setting information for M (M≥1) RS transmission resources (CSI-ResourceConfig), and list information of one or two trigger states (CSI-AperiodicTriggerStateList, CSI-SemiPersistentOnPUSCH-TriggerStateList). The configuration information for CSI measurement and report described above may be, more specifically, as described in Table 13 to Table 18 and related descriptions.

### CSI-ReportConfig

The IE CSI-ReportConfig is used to configure a periodic or semi-persistent report sent on PUCCH on the cell in which the CSI-ReportConfig is included, or to configure a semi-persistent or aperiodic report sent on PUSCH triggered by DCI received on the cell in which the CSI-ReportConfig is included (in this case, the cell on which the report is sent is determined by the received DCI). See TS 38.214 [19], clause 5.2.1.

### CSI-ReportConfig Information Element

```
  -- ASN1START
  -- TAG-CSI-REPORTCONFIG-START
```

| CSI-ReportConfig ::= | SEQUENCE { | |
|---|---|---|
| reportConfigId | CSI-ReportConfigId, | |
| carrier | ServCellIndex | OPTIONAL, -- |

Need S

| | |
|---|---|
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| reportConfigType | CHOICE { |
| periodic | SEQUENCE { |
| reportSlotConfig | CSI-ReportPeriodicityAndOffset, |

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUCCH | SEQUENCE { |

| | |
|---|---|
| reportSlotConfig | CSI-ReportPeriodicityAndOffset, |

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUSCH | SEQUENCE { |

| | |
|---|---|
| reportSlotConfig | ENUMERATED {sl5, sl10, sl20, |

sl40, sl80, sl160, sl320},

| | |
|---|---|
| reportSlotOffsetList | SEQUENCE (SIZE (1.. maxNrofUL- |

Allocations)) OF INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL- |

```
Allocations)) OF INTEGER(0..32)
      }
    },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |

| | |
|---|---|
| pdsch-BundleSizeForCSI | ENUMERATED {n2, n4} |

OPTIONAL -- Need S
},

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |
| cqi-FormatIndicator | ENUMERATED { widebandCQI, |

subbandCQI } OPTIONAL, -- Need R

| | |
|---|---|
| pmi-FormatIndicator | ENUMERATED { widebandPMI, |

subbandPMI } OPTIONAL, -- Need R

| | |
|---|---|
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(13)), |
| subbands12 | BIT STRING(SIZE(12)), |
| subbands13 | BIT STRING(SIZE(4)), |
| subbands14 | BIT STRING(SIZE(13)), |
| subbands15 | BIT STRING(SIZE(12)), |
| subbands16 | BIT STRING(SIZE(13)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

} OPTIONAL -- Need S

| | |
|---|---|
| } | OPTIONAL, |

-- Need R

| | |
|---|---|
| timeRestrictionForChannelMeasurements | ENUMERATED |

{configured, notConfigured},

| | |
|---|---|
| timeRestrictionForInterferenceMeasurements | ENUMERATED |

{configured, notConfigured},

| | |
|---|---|
| codebookConfig | CodebookConfig |

OPTIONAL, -- Need R

| | |
|---|---|
| dummy | ENUMERATED {n1, n2} |

OPTIONAL, -- Need R

| | |
|---|---|
| groupBasedBeamReporting | CHOICE { |

| | |
|---|---|
| enabled | NULL, |
| disabled | SEQUENCE { |
| nrofReportedRS | ENUMERATED {n1, n2, n3, n4} |

```
OPTIONAL -- Need S
      }
    },
    cqi-Table ENUMERATED {table1, table2, table3, spare1}
OPTIONAL, -- Need R
    subbandSize ENUMERATED {value1, value2},
    non-PMI-PortIndication SEQUENCE (SIZE (1..maxNrofNZP-CSI-
RS-ResourcesPerConfig)) OF PortIndexFor8Ranks OPTIONAL, -- Need R
    ...,
    [[
```

| | |
|---|---|
| semiPersistentOnPUSCH-v1530 | SEQUENCE { |
| reportSlotConfig-v1530 | ENUMERATED {sl4, sl8, sl16} |

| | |
|---|---|
| } | OPTIONAL |

```
-- Need R
    ]],
    [[
    semiPersistentOnPUSCH-v1610 SEQUENCE {
      reportSlotOffsetListDCI-0-2-r16 SEQUENCE (SIZE (1..
maxNrofUL-Allocations-r16)) OF INTEGER(0..32) OPTIONAL, -- Need R
      reportSlotOffsetListDCI-0-1-r16 SEQUENCE (SIZE (1..
maxNrofUL-Allocations-r16)) OF INTEGER(0..32) OPTIONAL -- Need R
```

| | |
|---|---|
| } | OPTIONAL, |

-- Need R

| | |
|---|---|
| aperiodic-v1610 | SEQUENCE { |

```
      reportSlotOffsetListDCI-0-2-r16 SEQUENCE (SIZE (1..
maxNrofUL-Allocations-r16)) OF INTEGER(0..32) OPTIONAL, -- Need R
      reportSlotOffsetListDCI-0-1-r16 SEQUENCE (SIZE (1..
maxNrofUL-Allocations-r16)) OF INTEGER(0..32) OPTIONAL -- Need R
```

| | |
|---|---|
| } | OPTIONAL, |

-- Need R

| | |
|---|---|
| reportQuantity-r16 | CHOICE { |
| cri-SINR-r16 | NULL, |
| ssb-Index-SINR-r16 | NULL |

| | |
|---|---|
| } | OPTIONAL, |

-- Need R

| | |
|---|---|
| codebookConfig-r16 | CodebookConfig-r16 |

```
OPTIONAL -- Need R
    ]]
  }
  CSI-ReportPeriodicityAndOffset ::= CHOICE {
```

| | |
|---|---|
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

| | |
|---|---|
| PUCCH-CSI-Resource ::= | SEQUENCE { |
| uplinkBandwidthPartId | BWP-Id, |
| pucch-Resource | PUCCH-ResourceId |

}

| | |
|---|---|
| PortIndexFor8Ranks ::= | CHOICE { |
| portIndex8 | SEQUENCE{ |

| | |
|---|---|
| rank1-8 | PortIndex8 |

OPTIONAL, -- Need R

| | |
|---|---|
| rank2-8 | SEQUENCE(SIZE(2)) OF PortIndex8 |

OPTIONAL, -- Need R

| | |
|---|---|
| rank3-8 | SEQUENCE(SIZE(3)) OF PortIndex8 |

OPTIONAL, -- Need R

| | |
|---|---|
| rank4-8 | SEQUENCE(SIZE(4)) OF PortIndex8 |

OPTIONAL, -- Need R

| | |
|---|---|
| rank5-8 | SEQUENCE(SIZE(5)) OF PortIndex8 |

OPTIONAL, -- Need R

| | |
|---|---|
| rank6-8 | SEQUENCE(SIZE(6)) OF PortIndex8 |

OPTIONAL, -- Need R

| | |
|---|---|
| rank7-8 | SEQUENCE(SIZE(7)) OF PortIndex8 |

OPTIONAL, -- Need R

| | |
|---|---|
| rank8-8 | SEQUENCE(SIZE(8)) OF PortIndex8 |

OPTIONAL -- Need R
},

| | |
|---|---|
| portIndex4 | SEQUENCE{ |

| | |
|---|---|
| rank1-4 | PortIndex4 |

OPTIONAL, -- Need R

| | |
|---|---|
| rank2-4 | SEQUENCE(SIZE(2)) OF PortIndex4 |

OPTIONAL, -- Need R

| | |
|---|---|
| rank3-4 | SEQUENCE(SIZE(3)) OF PortIndex4 |

OPTIONAL, -- Need R

| | |
|---|---|
| rank4-4 | SEQUENCE(SIZE(4)) OF PortIndex4 |

OPTIONAL -- Need R
},

| | |
|---|---|
| portIndex2 | SEQUENCE{ |

| | |
|---|---|
| rank1-2 | PortIndex2 |

OPTIONAL, -- Need R

| | |
|---|---|
| rank2-2 | SEQUENCE(SIZE(2)) OF PortIndex2 |

OPTIONAL -- Need R
},

| | |
|---|---|
| portIndex1 | NULL |

}

| | |
|---|---|
| PortIndex8::= | INTEGER (0..7) |
| PortIndex4::= | INTEGER (0..3) |
| PortIndex2::= | INTEGER (0..1) |

```
  -- TAG-CSI-REPORTCONFIG-STOP
  -- ASN1STOP
```

TABLE 13
CSI-ReportConfig field descriptions

carrier
Indicates in which serving cell the CSI-ResourceConfig indicated
below are to be found. If the field is absent, the resources are on the
same serving cell as this report configuration.
codebookConfig
Codebook configuration for Type-1 or Type-2 including codebook
subset restriction. Network does not configure codebookConfig and
codebookConfig-r16 simultaneously to a UE
cqi-FormatIndicator
Indicates whether the UE shall report a single (wideband) or
multiple (subband) CQI. (see TS 38.214 [19], clause 5.2.1.4).
cqi-Table
Which CQI table to use for CQI calculation (see TS 38.214 [19],
clause 5.2.2.1).
csi-IM-ResourcesForInterference
CSI IM resources for interference measurement. Csi-
ResourceConfigId of a CSI-ResourceConfig included in the
configuration of the serving cell indicated with the field “carrier”
above. The CSI-ResourceConfig indicated here contains only
CSI-IM resources. The bwp-Id in that CSI-ResourceConfig is the
same value as the bwp-Id in the CSI-ResourceConfig indicated by
resourcesForChannelMeasurement.
csi-ReportingBand
Indicates a contiguous or non-contiguous subset of subbands in
the bandwidth part which CSI shall be reported for. Each bit in the
bit-string represents one subband. The right-most bit in the bit
string represents the lowest subband in the BWP. The choice
determines the number of subbands (subbands3 for 3 subbands,
subbands4 for 4 subbands, and so on) (see TS 38.214 [19], clause
5.2.1.4). This field is absent if there are less than 24 PRBs (no sub
band) and present otherwise, the number of sub bands can be
from 3 (24 PRBs, sub band size 8) to 18 (72 PRBs, sub band
size 4).
dummy
This field is not used in the specification. If received it shall be
ignored by the UE.
groupBasedBeamReporting
Turning on/off group beam based reporting (see TS 38.214 [19],
clause 5.2.1.4).
non-PMI-PortIndication
Port indication for RI/CQI calculation. For each CSI-RS resource
in the linked ResourceConfig for channel measurement, a port
indication for each rank R, indicating which R ports to use.
Applicable only for non-PMI feedback (see TS 38.214 [19],
clause 5.2.1.4.2).
The first entry in non-PMI-PortIndication corresponds to the
NZP-CSI-RS-Resource indicated by the first entry in nzp-CSI-RS-
Resources in the NZP-CSI-RS-ResourceSet indicated in the first
entry of nzp-CSI-RS-ResourceSetList of the CSI-
ResourceConfig whose CSI-ResourceConfigId is indicated in a
CSI-MeasId together with the above CSI-ReportConfigId; the
second entry in non-PMI-PortIndication corresponds to the NZP-
CSI-RS-Resource indicated by the second entry in nzp-CSI-RS-
Resources in the NZP-CSI-RS-ResourceSet indicated in the
first entry of nzp-CSI-RS-ResourceSetList of the same CSI-
ResourceConfig, and soon until the NZP-CSI-RS-Resource
indicated by the last entry in nzp-CSI-RS-Resources in the in
the NZP-CSI-RS-ResourceSet indicated in the first entry of nzp-
CSI-RS-ResourceSetList of the same CSI-ResourceConfig. Then
the next entry corresponds to the NZP-CSI-RS-Resource
indicated by the first entry in nzp-CSI-RS-Resources in the
NZP-CSI-RS-ResourceSet indicated in the second entry of nzp-
CSI-RS-ResourceSetList of the same CSI-ResourceConfig and
so on.
nrofReportedRS
The number (N) of measured RS resources to be reported per
report setting in a non-group-based report. N <= N_max, where
N_max is either 2 or 4 depending on UE capability.
(sec TS 38.214 [19], clause 5.2.1.4) When the field is absent the
UE applies the value 1.
nzp-CSI-RS-ResourcesForInterference
NZP CSI RS resources for interference measurement. Csi-
ResourceConfigId of a CSI-ResourceConfig included in the
configuration of the serving cell indicated with the field “carrier”
above. The CSI-ResourceConfig indicated here contains only
NZP-CSI-RS resources. The bwp-Id in that CSI-ResourceConfig
is the same value as the bwp-Id in the CSI-ResourceConfig
indicated by resourcesForChannelMeasurement.
p0alpha
Index of the p0-alpha set determining the power control for this
CSI report transmission (see TS 38.214 [19], clause 6.2.1.2).
pdsch-BundleSizeForCSI
PRB bundling size to assume for CQI calculation when
reportQuantity is CRI/RI/i1/CQI. If the field is absent, the UE
assumes that no PRB bundling is applied (see TS 38.214 [19],
clause 5.2.1.4.2).
pmi-FormatIndicator
Indicates whether the UE shall report a single (wideband) or
multiple (subband) PMI. (see TS 38.214 [19], clause 5.2.1.4).
pucch-CSI-ResourceList
Indicates which PUCCH resource to use for reporting on
PUCCH.
reportConfigType
Time domain behavior of reporting configuration.
reportFreqConfiguration
Reporting configuration in the frequency domain. (see
TS 38.214 [19], clause 5.2.1.4).
reportQuantity
The CSI related quantities to report. See TS 38.214 [19], clause
5.2.1. If the field reportQuantity-r16 is present, UE shall ignore
reportQuantity (without suffix).
reportSlotConfig
Periodicity and slot offset (see TS 38.214 [19], clause 5.2.1.4).
If the field reportSlotConfig-v1530 is present, the UE shall ignore
the value provided in reportSlotConfig (without suffix).
reportSlotOffsetList, reportSlotOffsetListDCI-0-1,
reportSlotOffsetListDCI-0-2
Timing offset Y for semi persistent reporting using PUSCH. This
field lists the allowed offset values. This list must have the same
number of entries as the pusch-TimeDomainAllocationList in
PUSCH-Config. A particular value is indicated in DCI. The
network indicates in the DCI field of the UL grant, which of the
configured report slot offsets the UE shall apply. The DCI value 0
corresponds to the first report slot offset in this list, the DCI value 1
corresponds to the second report slot offset in this list, and so on.
The first report is transmitted in slot n + Y, second report in
n + Y + P, where P is the configured periodicity.
Timing offset Y for aperiodic reporting using PUSCH. This field
lists the allowed offset values. This list must have the same number
of entries as the pusch-TimeDomainAllocationList in PUSCH-
Config. A particular value is indicated in DCI. The network
indicates in the DCI field of the UL grant, which of the configured
report slot offsets the UE shall apply. The DCI value 0 corresponds
to the first report slot offset in this list, the DCI value 1
corresponds to the second report slot offset in this list, and so on
(see TS 38.214 [19], clause 6.1.2.1). The field reportSlotOffsetList
applies to DCI format 0_0, the field reportSlotOffsetListDCI-0-
1 applies to DCI format 0_1 and the field reportSlotOffsetListDCI-
0-2 applies to DCI format 0_2 (see TS 38.214 [19], clause 6.1.2.1).
resourcesForChannelMeasurement
Resources for channel measurement. Csi-ResourceConfigId of a
CSI-ResourceConfig included in the configuration of the serving
cell indicated with the field “carrier” above. The CSI-
ResourceConfig indicated here contains only NZP-CSI-RS
resources and/or SSB resources. This CSI-ReportConfig is
associated with the DL BWP indicated by bwp-Id in that CSI-
ResourceConfig.
subbandSize
Indicates one out of two possible BWP-dependent values for the
subband size as indicated in TS 38.214 [19], table 5.2.1.4-2 . If csi-
ReportingBand is absent, the UE shall ignore this field.
timeRestrictionForChannelMeasurements
Time domain measurement restriction for the channel (signal)
measurements (see TS 38.214 [19], clause 5.2.1.1).
timeRestrictionForInterferenceMeasurements
Time domain measurement restriction for interference
measurements (see TS 38.214 [19], clause 5.2.1.1).

### CSI-ResourceConfig

The IE CSI-ResourceConfig defines a group of one or more NZP-CSI-RS-ResourceSet, CSI-IM-ResourceSet and/or CSI-SSB-ResourceSet.

### CSI-ResourceConfig Information Element

```
  -- ASN1START
  -- TAG-CSI-RESOURCECONFIG-START
```

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |

```
        nzp-CSI-RS-ResourceSetList SEQUENCE (SIZE
(1..maxNrofNZP-CSI-RS-ResourceSetsPerConfig)) OF NZP-CSI-RS-ResourceSetId
OPTIONAL, -- Need R
        csi-SSB-ResourceSetList SEQUENCE (SIZE (1..maxNrofCSI-
SSB-ResourceSetsPerConfig)) OF CSI-SSB-ResourceSetId OPTIONAL -- Need R
      },
      csi-IM-ResourceSetList SEQUENCE (SIZE (1..maxNrofCSI-IM-
ResourceSetsPerConfig)) OF CSI-IM-ResourceSetId
    },
```

| | |
|---|---|
| bwp-Id | BWP-Id, |
| resourceType | ENUMERATED { aperiodic, semiPersistent, |

```
periodic },
    ...
  }
  -- TAG-CSI-RESOURCECONFIG-STOP
  -- ASN1STOP
```

TABLE 14
CSI-ResourceConfig field descriptions

bwp-Id
The DL BWP which the CSI-RS associated with this CSI-
ResourceConfig are located in (see TS 38.214 [19], clause 5.2.1.2.
csi-IM-ResourceSetList
List of references to CSI-IM resources used for beam measurement
and reporting in a CSI-RS resource set. Contains up to maxNrofCSI-
IM-ResourceSetsPerConfig resource sets if resourceType is
“aperiodic” and 1 otherwise (see TS 38.214 [19], clause 5.2.1.2).
csi-ResourceConfigId
Used in CSI-ReportConfig to refer to an instance of CSI-
ResourceConfig.
csi-SSB-ResourceSetList
List of references to SSB resources used for beam measurement and
reporting in a CSI-RS resource set (see TS 38.214 [19], clause
5.2.1.2).
nzp-CSI-RS-ResourceSetList
List of references to NZP CSI-RS resources used for beam
measurement and reporting in a CSI-RS resource set. Contains up
to maxNrofNZP-CSI-RS-ResourceSetsPerConfig resource sets
if resourceType is “aperiodic” and 1 otherwise (see TS 38.214 [19],
clause 5.2.1.2).
resourceType
Time domain behavior of resource configuration (see TS 38.214
[19], clause 5.2.1.2). It does not apply to resources provided in the
csi-SSB-ResourceSetList.

### NZP-CSI-RS-ResourceSet

The IE NZP-CSI-RS-ResourceSet is a set of Non-Zero-Power (NZP) CSI-RS resources (their IDs) and set-specific parameters.

### NZP-CSI-RS-ResourceSet Information Element

| -- ASN1START | |
|---|---|
| -- TAG-NZP-CSI-RS-RESOURCESET-START | |
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP- |
| CSI-RS-ResourcesPerSet)) OF NZP-CSI-RS-ResourceId, | |
| repetition | ENUMERATED { on, off } |
| OPTIONAL, -- Need S | |
| aperiodicTriggeringOffset | INTEGER(0..6) |
| OPTIONAL, -- Need S | |
| trs-Info | ENUMERATED {true} |
| OPTIONAL, -- Need R | |
| ..., | |
| [[ | |
| aperiodicTriggeringOffset-r16 | INTEGER(0..31) |

```
OPTIONAL -- Need S
    ]]
  }
  -- TAG-NZP-CSI-RS-RESOURCESET-STOP
  -- ASN1STOP
```

TABLE 15
NZP-CSI-RS-ResourceSet field descriptions

aperiodicTriggeringOffset, aperiodicTriggeringOffset-r16
Offset X between the slot containing the DCI that triggers a set of
aperiodic NZP CSI-RS resources and the slot in which the CSI-RS
resource set is transmitted. For aperiodicTriggeringOffset, the
value 0 corresponds to 0 slots, value 1 corresponds to 1 slot,
value 2 corresponds to 2 slots, value 3 corresponds to 3 slots,
value 4 corresponds to 4 slots, value 5 corresponds to 16 slots,
value 6 corresponds to 24 slots. For aperiodicTriggeringOffset-
r16, the value indicates the number of slots. The network
configures only one of the fields. When neither field is included,
the UE applies the value 0.
nzp-CSI-RS-Resources
NZP-CSI-RS-Resources associated with this NZP-CSI-RS
resource set (see TS 38.214 [19], clause 5.2). For CSI, there are
at most 8 NZP CSI RS resources per resource set.
repetition
Indicates whether repetition is on/off. If the field is set to off or
if the field is absent, the UE may not assume that the NZP-CSI-
RS resources within the resource set are transmitted with the
same downlink spatial domain transmission filter (see TS
38.214 [19], clauses 5.2.2.3.1 and 5.1.6.1.2). It can only be
configured for CSI-RS resource sets which are associated with
CSI-ReportConfig with report of L1 RSRP or “no report”.
trs-Info
Indicates that the antenna port for all NZP-CSI-RS resources
in the CSI-RS resource set is same. If the field is absent or
released the UE applies the value false (see TS 38.214 [19],
clause 5.2.2.3.1).

### CSI-SSB-ResourceSet

The IE CSI-SSB-ResourceSet is used to configure one SS/PBCH (synchronization signal/physical broadcast channel) block resource set which refers to SS/PBCH as indicated in ServingCellConfigCommon.

### CSI-SSB-ResourceSet Information Element

| -- ASN1START | |
|---|---|
| -- TAG-CSI-SSB-RESOURCESET-START | |
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI- |

```
SSB-ResourcePerSet)) OF SSB-Index,
    ...
  }
  -- TAG-CSI-SSB-RESOURCESET-STOP
  -- ASN1STOP
```

### CSI-IM-ResourceSet

The IE CSI-IM-ResourceSet is used to configure a set of one or more CSI Interference Management (IM) resources (their IDs) and set-specific parameters.

### CSI-IM-ResourceSet Information Element

```
  -- ASN1START
  -- TAG-CSI-IM-RESOURCESET-START
```

| | |
|---|---|
| CSI-IM-ResourceSet ::= | SEQUENCE { |
| csi-IM-ResourceSetId | CSI-IM-ResourceSetId, |
| csi-IM-Resources | SEQUENCE (SIZE(1..maxNrofCSI-IM- |

```
ResourcesPerSet)) OF CSI-IM-ResourceId,
    ...
  }
  -- TAG-CSI-IM-RESOURCESET-STOP
  -- ASN1STOP
```

TABLE 16
CSI-IM-ResourceSet field descriptions

csi-IM-Resources
CSI-IM-Resources associated with this CSI-IM-ResourceSet
(see TS 38.214 [19], clause 5.2)

CSI-Aperiodic TriggerStateList

The CSI-AperiodicTriggerStateList IE is used to configure the UE with a list of aperiodic trigger states. Each codepoint of the DCI field “CSI request” is associated with one trigger state. Upon reception of the value associated with a trigger state, the UE will perform measurement of CSI-RS (reference signals) and aperiodic reporting on L1 according to all entries in the associatedReportConfigInfoList for that trigger state.

### CSI-AperiodicTriggerStateList Information Element

```
  -- ASN1START
  -- TAG-CSI-APERIODICTRIGGERSTATELIST-START
```

| | |
|---|---|
| CSI-AperiodicTriggerStateList ::= | SEQUENCE (SIZE |

(1..maxNrOfCSI-AperiodicTriggers)) OF CSI-AperiodicTriggerState

| | |
|---|---|
| CSI-AperiodicTriggerState ::= | SEQUENCE { |
| associatedReportConfigInfoList | SEQUENCE |

```
(SIZE(1..maxNrofReportConfigPerAperiodicTrigger)) OF CSI-
AssociatedReportConfigInfo,
    ...
  }
```

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS- |

ResourceSetsPerConfig),

| | |
|---|---|
| qcl-info | SEQUENCE (SIZE(1..maxNrofAP-CSI- |

RS-ResourcesPerSet)) OF TCI-StateId OPTIONAL -- Cond Aperiodic
},

| | |
|---|---|
| csi-SSB-ResourceSet | INTEGER (1..maxNrofCSI-SSB- |

ResourceSetsPerConfig)
},

| | |
|---|---|
| csi-IM-ResourcesForInterference | INTEGER(1..maxNrofCSI-IM- |

```
ResourceSetsPerConfig) OPTIONAL, -- Cond CSI-IM-ForInterference
    nzp-CSI-RS-ResourcesForInterference INTEGER (1..maxNrofNZP-
CSI-RS-ResourceSetsPerConfig) OPTIONAL, -- Cond NZP-CSI-RS-ForInterference
    ...
  }
  -- TAG-CSI-APERIODICTRIGGERSTATELIST-STOP
  -- ASN1STOP
```

TABLE 17
CSI-AssociatedReportConfigInfo field descriptions

csi-IM-ResourcesForInterference
CSI-IM-ResourceSet for interference measurement. Entry number in csi-
IM-ResourceSetList in the CSI-ResourceConfig indicated by csi-IM-
ResourcesForInterference in the CSI-ReportConfig indicated by
reportConfigId above (1 corresponds to the first entry, 2 to the
second entry, and so on). The indicated CSI-IM-ResourceSet should
have exactly the same number of resources like the NZP-CSI-RS-
ResourceSet indicated in nzp-CSI-RS-ResourcesforChannel.
csi-SSB-ResourceSet
CSI-SSB-ResourceSet for channel measurements. Entry number in csi-
SSB-ResourceSetList in the CSI-ResourceConfig indicated by
resourcesForChannelMeasurement in the CSI-ReportConfig indicated
by reportConfigId above (1 corresponds to the first entry, 2 to the
second entry, and so on).
nzp-CSI-RS-ResourcesForInterference
NZP-CSI-RS-ResourceSet for interference measurement. Entry
number in nzp-CSI-RS-ResourceSetList in the CSI-ResourceConfig
indicated by nzp-CSI-RS-ResourcesForInterference in the CSI-
ReportConfig indicated by reportConfigId above (1 corresponds to the
first entry, 2 to the second entry, and so on).
qcl-info
List of references to TCI-States for providing the QCL source and QCL
type for each NZP-CSI-RS-Resource listed in nzp-CSI-RS-Resources
of the NZP-CSI-RS-ResourceSet indicated by nzp-CSI-RS-
ResourcesforChannel. Each TCI-StateId refers to the TCI-State
which has this value for tci-StateId and is defined in tci-
StatesToAddModList in the PDSCH-Config included in the BWP-
Downlink corresponding to the serving cell and to the DL BWP to
which the resourcesForChannelMeasurement (in the CSI-
ReportConfig indicated by reportConfigId above) belong to. First
entry in qcl-info-forChannel corresponds to first entry in nzp-CSI-RS-
Resources of that NZP-CSI-RS-ResourceSet, second entry in qcl-info-
forChannel corresponds to second entry in nzp-CSI-RS-Resources,
and so on (see TS 38.214 [19], clause 5.2.1.5.1)
reportConfigId
The reportConfigId of one of the CSI-ReportConfigToAddMod
configured in CSI-MeasConfig
resourceSet
NZP-CSI-RS-ResourceSet for channel measurements. Entry number
in nzp- CSI-RS-ResourceSetList in the CSI-ResourceConfig
indicated by resourcesForChannelMeasurement in the CSI-
ReportConfig indicated by reportConfigId above (1 corresponds to the
first entry, 2 to the second entry, and so on).

| Conditional Presence | Explanation |
|---|---|
| Aperiodic | The field is mandatory present if the |
| | NZP-CSI-RS-Resources in the associated |
| | resourceSet have the resourceType |
| | aperiodic. The field is absent otherwise. |
| CSI-IM- | This field is optional need M if the CSI- |
| ForInterference | ReportConfig identified by |
| | reportConfigId is configured with csi-IM- |
| | ResourcesForInterference; otherwise it is |
| | absent. |
| NZP-CSI-RS- | This field is optional need M if the CSI- |
| ForInterference | ReportConfig identified by reportConfigId |
| | is configured with nzp-CSI-RS- |
| | ResourcesForInterference; otherwise it |
| | is absent. |

The CSI-SemiPersistentOnPUSCH-TriggerStateList IE is used to configure the UE with list of trigger states for semi-persistent reporting of channel state information on L1. See also TS 38.214 [19], clause 5.2.

### CSI-SemiPersistentOnPUSCH-TriggerStateList

```
TABLE 18
CSI-SemiPersistentOnPUSCH-TriggerStateList information element
-- ASN1START
-- TAG-CSI-SEMIPERSISTENTONPUSCHTRIGGERSTATELIST-START
CSI-SemiPersistentOnPUSCH-TriggerStateList ::= SEQUENCE(SIZE
(1..maxNrOfSemiPersistentPUSCH-Triggers)) OF CSI-SemiPersistentOnPUSCH-
TriggerState
CSI-SemiPersistentOnPUSCH-TriggerState ::= SEQUENCE {
  associatedReportConfigInfo CSI-ReportConfigId,
  ...
}
-- TAG-CSI-SEMIPERSISTENTONPUSCHTRIGGERSTATELIST-STOP
-- ASN1STOP
```

With respect to the aforementioned CSI report settings (CSI-ReportConfig), each report setting CSI-ReportConfig may be associated with one downlink (DL) bandwidth part identified by a higher-layer parameter bandwidth part identifier (bwp-id) given by CSI resource setting CSI-ResourceConfig associated with the corresponding report setting. As time domain reporting for each report setting CSI-ReportConfig, “aperiodic”, “semi-persistent”, and “periodic” schemes may be supported, which may be configured for the terminal by the base station via parameter reportConfigType configured from a higher layer. A semi-persistent CSI report method may support a “PUCCH-based semi-persistent (semi-PersistentOnPUCCH)” method and a “PUSCH-based semi-persistent (semi-PersistentOnPUSCH)” method. For the periodic or semi-persistent CSI report method, a PUCCH or PUSCH resource in which CSI is to be transmitted may be configured for the terminal by the base station via higher-layer signaling. The periodicity and slot offset of a PUCCH or PUSCH resource in which CSI is to be transmitted may be given by a numerology of an uplink (UL) bandwidth part configured to transmit CSI reporting. For the aperiodic CSI report method, a PUSCH resource in which CSI is to be transmitted may be scheduled for the terminal by the base station via L1 signaling (e.g., aforementioned DCI format 0_1).

With respect to the aforementioned CSI resource settings (CSI-ResourceConfig), each CSI resource setting CSI-ReportConfig may include S (≥1) CSI resource sets (e.g., given via higher-layer parameter csi-RS-ResourceSetList). A CSI resource set list may include a non-zero power (NZP) CSI-RS resource set and an SS/PBCH block set or may include a CSI-interference measurement (CSI-IM) resource set. Each CSI resource setting may be positioned in a downlink (DL) bandwidth part identified by higher-layer parameter bwp-id and may be connected to a CSI report setting in the same downlink bandwidth part. A time domain operation of a CSI-RS resource in CSI resource setting may be configured to be one of “aperiodic”, “periodic”, or “semi-persistent” from higher-layer parameter resourceType. With respect to the periodic or semi-persistent CSI resource setting, the number of CSI-RS resource sets may be limited to S (S=1), and the configured periodicity and slot offset may be given based on numerology of the downlink bandwidth part identified by bwp-id. One or more CSI resource settings for channel or interference measurement may be configured for the terminal by the base station via higher-layer signaling, and for example, at least one CSI resource setting may include at least one of the following CSI resources.
CSI-IM resource for interference measurement
NZP CSI-RS resource for interference measurement
NZP CSI-RS resource for channel measurement

With respect to CSI-RS resource sets associated with a resource setting in which higher-layer parameter resourceType is configured to be “aperiodic”, “periodic”, or “semi-persistent”, a trigger state of CSI report setting having reportType configured to be “aperiodic”, and a resource setting for channel or interference measurement on one or multiple component cells (CCs) may be configured via higher-layer parameter CSI-AperiodicTriggerStateList.

Aperiodic CSI reporting of the terminal may be performed using a PUSCH, periodic CSI reporting may be performed using a PUCCH, and semi-persistent CSI reporting may be performed using a PUSCH when triggered or activated via DCI, and may be performed using a PUCCH after activated via a MAC control element (MAC CE). As described above, CSI resource setting may also be configured to be aperiodic, periodic, or semi-persistent. Combinations between CSI report settings and CSI resource configurations may be supported based on Table 19 (Table 5.2.1.4-1: Triggering/Activation of CSI Reporting for the possible CSI-RS Configurations) below.

TABLE 19

| | | Semi- | |
|---|---|---|---|
| CSI-RS | Periodic CSI | Persistent CSI | Aperiodic CSI |
| Configuration | Reporting | Reporting | Reporting |
| Periodic CSI-RS | No dynamic | For reporting | Triggered by |
| | triggering/ | on PUCCH, the | DCI; |
| | activation | UE receives an | additionally, |
| | | activation | activation |
| | | command [10, | command [10, |
| | | TS 38.321]; for | TS 38.321] |
| | | reporting on | possible as |
| | | PUSCH, the UE | defined in |
| | | receives | Subclause |
| | | triggering on | 5.2.1.5.1. |
| | | DCI | |
| Semi-Persistent | Not Supported | For reporting | Triggered by |
| CSI-RS | | on PUCCH, the | DCI; |
| | | UE receives an | additionally, |
| | | activation | activation |
| | | command [10, | command [10, |
| | | TS 38.321]; for | TS 38.321] |
| | | reporting on | possible as |
| | | PUSCH, the UE | defined in |
| | | receives | Subclause |
| | | triggering on | 5.2.1.5.1. |
| | | DCI | |
| Aperiodic | Not Supported | Not Supported | Triggered by |
| CSI-RS | | | DCI; |
| | | | additionally, |
| | | | activation |
| | | | command [10, |
| | | | TS 38.321] |
| | | | possible as |
| | | | defined in |
| | | | Subclause |
| | | | 5.2.1.5.1. |

Aperiodic CSI reporting may be triggered by a “CSI request” field in DCI format 0_1 described above, which corresponds to scheduling DCI for a PUSCH. The terminal may monitor a PDCCH, may acquire DCI format 0_1, and may acquire scheduling information of a PUSCH and a CSI request indicator. A CSI request indicator may be configured to have NTS(=0, 1, 2, 3, 4, 5, or 6) bits, and may be determined by higher-layer signaling (reportTriggerSize). One trigger state among one or multiple aperiodic CSI report trigger states which may be configured via higher-layer signaling (CSI-AperiodicTriggerStateList) may be triggered by the CSI request indicator.
When all bits in the CSI request field are 0, this may indicate that CSI reporting is not requested.
If the number M of configured CSI trigger states in CSI-AperiodicTriggerStateLite is larger than 2NTs−1, M CSI trigger states may be mapped to 2NTs−1 trigger states according to a predefined mapping relationship, and one trigger state among the 2NTs−1 trigger states may be indicated by the CSI request field.
If the number M of configured CSI trigger states in CSI-AperiodicTriggerStateLite is less than or equal to 2NTs−1, one of the M CSI trigger states may be indicated by the CSI request field.

Table 20 below may show an example of relationships between CSI request indicators and CSI trigger states that may be indicated by the indicators.

TABLE 20

| CSI | | | |
|---|---|---|---|
| request | CSI trigger | CSI- | CSI- |
| field | state | ReportConfigId | ResourceConfigId |
| 00 | no CSI request | N/A | N/A |
| 01 | CSI trigger | CSI report#1 | CSI resource#1, |
| | state#1 | CSI report#2 | CSI resource#2 |
| 10 | CSI trigger | CSI report#3 | CSI resource#3 |
| | state#2 | | |
| 11 | CSI trigger | CSI report#4 | CSI resource#4 |
| | state#3 | | |

The terminal may measure a CSI resource in a CSI trigger state triggered via the CSI request field, and then generate CSI (including at least one of the CQI, PMI, CRI, SSBRI, LI, RI, or L1-RSRP described above) based on the measurement. The terminal may transmit the acquired CSI by using the PUSCH scheduled via corresponding DCI format 0_1. If one bit corresponding to an uplink data indicator (UL-SCH indicator) in DCI format 0_1 indicates “1”, the terminal may multiplex uplink data (UL-SCH) and the acquired CSI on the PUSCH resource scheduled by DCI format 0_1 so as to transmit the same. If one bit corresponding to the uplink data indicator (UL-SCH indicator) in DCI format 0_1 indicates “0”, the terminal may map only CSI to the PUSCH resource scheduled by DCI format 0_1 without uplink data (UL-SCH) so as to transmit the same.

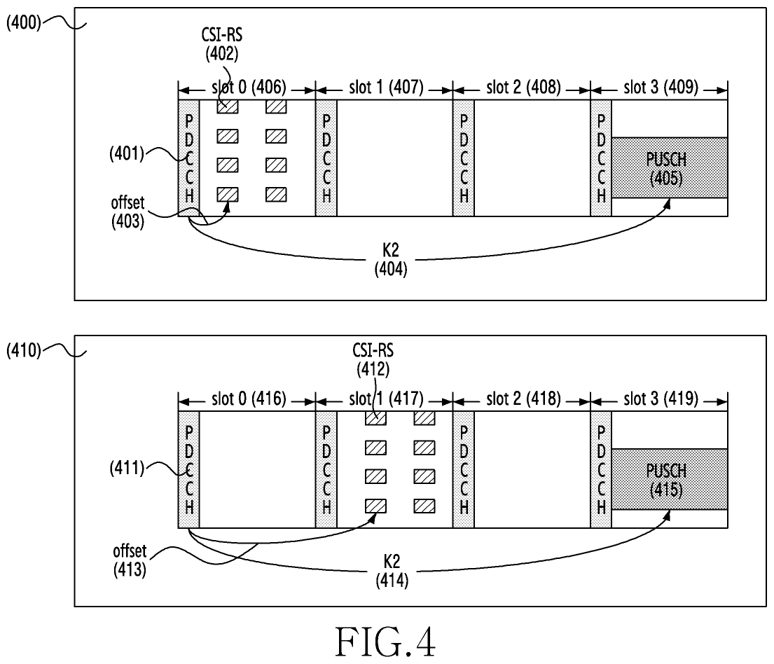

FIG. 4 shows diagrams illustrating an aperiodic CSI report method according to an embodiment of the disclosure.

Referring to FIG. 4, a terminal may acquire DCI format 0_1 by monitoring a PDCCH 401, and may acquire scheduling information and CSI request information for a PUSCH 405 therefrom. The terminal may acquire resource information of a CSI-RS 402 to be measured, from a received CSI request indicator. The terminal may determine a time point at which the terminal needs to measure a resource of the CSI-RS 402, based on a time point at which DCI format 0_1 is received, and a parameter for an offset 403 or 413 (e.g., aforementioned aperiodicTriggeringOffset) in a CSI resource set configuration (e.g., an NZP CSI-RS resource set configuration (NZP-CSI-RS-ResourceSet)). More specifically, the terminal may be configured with offset value X of parameter aperiodicTriggeringOffset in the NZP-CSI-RS resource set configuration from a base station via higher-layer signaling, and the configured offset value X may refer to an offset between a slot in which DCI for triggering of aperiodic CSI reporting is received, and a slot in which a CSI-RS resource is transmitted. For example, values of parameter aperiodicTriggeringOffset and offset values X may have mapping relationships as shown in Table 21 below.

TABLE 21

| aperiodicTriggeringOffset | Offset X |
|---|---|
| 0 | 0 slot |
| 1 | 1 slot |
| 2 | 2 slots |
| 3 | 3 slots |
| 4 | 4 slots |
| 5 | 16 slots |
| 6 | 24 slots |

An example 400 of FIG. 4 shows an example in which aforementioned offset value X is configured to be 0 (X=0). In this case, the terminal may receive the CSI-RS 402 in a slot (corresponding to slot 0 406 of FIG. 4) in which DCI format 0_1 that triggers aperiodic CSI reporting is received, and may report CSI information, which is measured based on the received CSI-RS, to the base station via the PUSCH 405. The terminal may acquire, from DCI format 0_1, scheduling information (information corresponding to each field of DCI format 0_1 described above) on the PUSCH 405 for CSI reporting. For example, in DCI format 0_1, the terminal may acquire information on a slot in which the PUSCH 405 is to be transmitted, from time domain resource allocation information for the PUSCH 405 described above. In the example 400 of FIG. 4, the terminal acquires 3 as a K2 value 404 and 414 corresponding to a slot offset value for PDCCH-to-PUSCH, and accordingly, the PUSCH 405 may be transmitted in slot 3 409, which is spaced 2 slots apart from slot 1 407 and spaced 3 slots apart from slot 0 406, i.e., a time point at which the PDCCH 401 has been received.

In an example 410 of FIG. 4, the terminal may acquire DCI format 0_1 by monitoring a PDCCH 411, and may acquire scheduling information and CSI request information for a PUSCH 415 therefrom. The terminal may acquire resource information of a CSI-RS 412 to be measured, from a received CSI request indicator. The example 410 of FIG. 4 shows an example in which offset value X for CSI-RS described above is configured to be 1 (X=1). In this case, the terminal may receive the CSI-RS 412 in a slot (corresponding to slot 0 416 of FIG. 4, which is followed by slot 1 417, slot 2 418, and slot 3 419) in which DCI format 0_1 triggering aperiodic CSI reporting is received, and may report CSI information, which is measured based on the received CSI-RS, to the base station via the PUSCH 415.

The aperiodic CSI report may include at least one of or both CSI part 1 and CSI part 2, and when the aperiodic CSI report is transmitted via the PUSCH, the aperiodic CSI report may be multiplexed on a transport block. After CRC is inserted into an input bit of aperiodic CSI for multiplexing, encoding and rate matching may be performed, and then transmission may be performed by mapping to resource elements within the PUSCH in a specific pattern. The CRC insertion may be omitted depending on a coding method or a length of the input bit. The number of modulation symbols, which is calculated for rate matching during multiplexing of CSI part I or CSI part 2 included in the aperiodic CSI report, may be calculated as shown in Table 22.

```
TABLE 22
    For CSI part 1 transmission on PUSCH not using repetition type B
with UL-SCH, the number of coded modulation symbols per layer for
CSI part 1 transmission, denoted as Q′_{CSI-part1}, is determined as follows:
Equation 6
  ${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ ,$ $⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} \}$
    For CSI part 1 transmission on an actual repetition of a PUSCH with
repetition Type B with UL-SCH, the number of coded modulation
symbols per layer for CSI part 1 transmission, denoted as Q′_{CSI-part1},
is determined as follows:
Equation 7
  ${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ ,$ $⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} ,$ ${\sum }_{l = 0}^{{N}_{symb , actual}^{PUSCH} - 1} {M}_{sc , actual}^{UCI} ( l ) - {Q}_{ACK / CG - UCI}^{′} \}$
    For CSI part 1 transmission on PUSCH without UL-SCH, the number
of coded modulation symbols per layer for CSI part 1 transmission,
denoted as Q′_{CSI-part1}, is determined as follows:
    if there is CSI part 2 to be transmitted on the PUSCH,
Equation 8
  ${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$ $else$ ${Q}_{CSI - 1}^{′} {\sum }_{l = 0}^{{N}_{symb , all}^{PUSCH} - 1} {M}_{sc}^{UCI} ( l ) - {Q}_{ACK}^{′}$ $end if$
    For CSI part 2 transmission on PUSCH not using repetition type B
with UL-SCH, the number of coded modulation symbols per layer for
CSI part 2 transmission, denoted as Q′_{CSI-part2}, is determined as follows:
Equation 9
  ${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ ,$ $⌈ α \cdot {\sum }_{l = 0}^{{N}_{symb , all}^{PUSCH} - 1} {M}_{sc}^{UCI} ( l ) ⌉ - {Q}_{\frac{ACK}{CG} - UCI}^{′} - {Q}_{CSI - 1}^{′} \}$
    For CSI part 2 transmission on an actual repetition of a PUSCH with
repetition Type B with UL-SCH, the number of coded modulation
symbols per layer for CSI part 2 transmission, denoted as Q′_{CSI-part2},
is determined as follows:
Equation 10
  ${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l ) )}{{\sum }_{r = 0}^{{C}_{UL - SCH} - 1} {K}_{r}} ⌉ ,$ $⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} - {Q}_{CSI - 1}^{′} ,$ ${\sum }_{l = 0}^{{N}_{symb , actual}^{PUSCH} - 1} {M}_{sc , actual}^{UCI} ( l ) - {Q}_{ACK / CG - UCI}^{′} - {Q}_{CSI - 1}^{′} \}$
    For CSI part 2 transmission on PUSCH without UL-SCH, the number
of coded modulation symbols per layer for CSI part 2 transmission,
denoted as Q′_{CSI-part2}, is determined as follows:
Equation 11
      ${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′}$
```

Specifically, for repeated PUSCH transmission schemes A and B, the terminal may multiplex the aperiodic CSI report only on a first repeated transmission among repeated PUSCH transmissions, so as to transmit the same. This is because the multiplexed aperiodic CSI report information is encoded in a polar code scheme, and in this case, for multiplexing on multiple PUSCH repetitions, respective PUSCH repetitions need to have the same frequency and time resource allocation, and since respective actual repetitions may have different OFDM symbol lengths particularly for PUSCH repetition type B, the aperiodic CSI report may be transmitted by being multiplexed on only the first PUSCH repetition.

In addition, for repeated PUSCH transmission scheme B, when the terminal receives DCI for activation of semi-persistent CSI reporting or scheduling of aperiodic CSI reporting without scheduling for a transport block, a value of nominal repetition may be assumed to be 1 even if the number of repeated PUSCH transmissions, which is configured via higher-layer signaling, is greater than 1. In addition, when the aperiodic or semi-persistent CSI reporting is scheduled or activated without scheduling for a transport block, based on repeated PUSCH transmission scheme B, the terminal may expect that a first nominal repetition is identical to a first actual repetition. With respect to the PUSCH transmitted while including semi-persistent CSI, based on repeated PUSCH transmission scheme B, without scheduling for DCI after the semi-persistent CSI reporting has been activated via the DCI, if the first nominal repetition is different from the first actual repetition, transmission for the first nominal repetition may be ignored.

### [PUCCH: UCI on PUSCH]

In the 5G communication system, when an uplink control channel overlaps with an uplink data channel and satisfies a transmission time condition, or when L1 signaling or higher signaling indicates transmission of uplink control information via the uplink data channel, the uplink control information may be included in the uplink data channel so as to be transmitted. In this case, a total of three pieces of uplink control information of HARQ-ACK, CSI part 1, and CSI part 2 may be transmitted via the uplink data channel, and each piece of uplink control information may be mapped to a PUSCH according to a predetermined multiplexing rule.

More specifically, in a first operation, if the number of HARQ-ACK information bits to be included in the PUSCH is 2 bits or less, the terminal may reserve an RE for transmission of HARQ-ACK in advance. In this case, a method of determining a resource to be reserved by the terminal is the same as a second operation. However, the number and positions of REs to be reserved may be determined by assuming that the number of HARQ-ACK bits is 2. For example, the terminal may perform calculation based on Oack=2 in Equation 12-A below. In the second operation, if the number of HARQ-ACK information bits to be transmitted by the terminal is greater than 2 bits, the terminal may map HARQ-ACK from a first OFDM symbol including no DMRS after a first DMRS symbol. In a third operation, the terminal may map CSI part 1 to the PUSCH. In this case, CSI part 1 may be mapped from the first OFDM symbol other than a DMRS, and may not be mapped to the RE reserved in the first operation and the RE to which HARQ-ACK is mapped in the second operation.

In a fourth operation, the terminal may map CSI part 2 to the PUSCH. In this case, CSI part 2 may be mapped from the first OFDM symbol other than a DMRS, and may not be mapped to an RE where CSI part 1 is located and an RE where the HARQ-ACK mapped to the RE in the second operation is located. However, CSI part 2 may be mapped to the RE reserved in the first operation. When a UL-SCH exists, the terminal may map the UL-SCH to the PUSCH. In this case, the UL-SCH may be mapped from the first OFDM symbol other than a DMRS, and may not be mapped to the RE where CSI part 1 is located, the RE where the HARQ-ACK mapped to the RE in the second operation is located, and the RE where CSI part 2 is located. However, CSI part 2 may be mapped to the RE reserved in the first operation.

In a fifth operation, if the HARQ-ACK has less than 2 bits, the terminal may puncture the HARQ-ACK and map the same to the RE reserved in the first operation. The number of REs to which the HARQ-ACK is mapped may be calculated based on the actual number of HARQ-ACKs. For example, the number of REs to which HARQ-ACK is actually mapped may be less than the number of REs reserved in the first operation. The puncturing may refer to mapping ACK instead of already mapped CSI part 2 or UL-SCH even if, in the fourth operation, the CSI part 2 or UL-SCH is mapped to the RE to which HARQ-ACK needs to be mapped. CSI part 1 may not be mapped to the reserved RE, so that puncturing by HARQ-ACK may not occur. This may indicate that, compared to CSI part 2, CSI part 1 has a higher priority and is decoded better. If the number of bits (or the number of modulated symbols) of uplink control information to be mapped to the PUSCH is greater than the number of bits (or REs) available for uplink control information mapping in a corresponding OFDM symbol to be mapped, frequency axis RE interval d between modulated symbols of the uplink control information to be mapped may be configured so that d=1. If the number of bits (or the number of modulated symbols) of the uplink control information to be mapped to the PUSCH is less than the number of bits (or REOs) available for uplink control information mapping in the corresponding OFDM symbol to be mapped, frequency axis RE interval d between modulated symbols of the uplink control information to be mapped may be configured so that d=floor (#of available bits on l-OFDM symbol/#of unmapped UCI bits at the beginning of l-OFDM symbol).

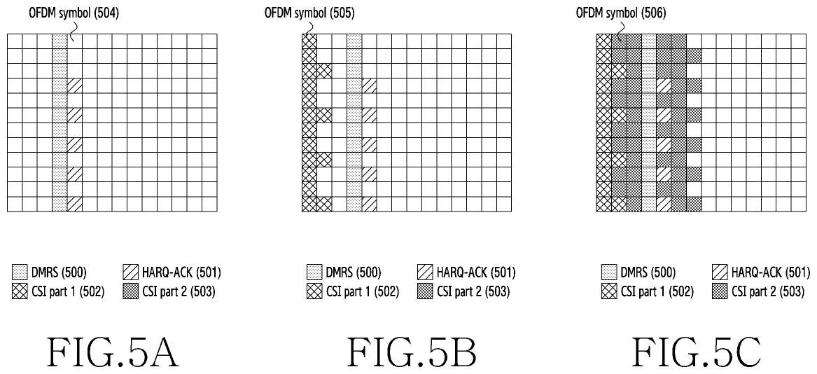

FIGS. 5A, 5B, and 5C illustrate uplink control information being mapped to a PUSCH according to various embodiments of the disclosure.

Referring to FIGS. 5A, 5B, and 5C, the number of HARQ-ACK symbols to be mapped to a PUSCH may be assumed to be 5, and the PUSCH may be assumed to be configured or scheduled with one resource block, in FIGS. 5A, 5B, and 5C. First, referring to FIG. 5A, a terminal may map HARQ-ACK 501 of 5 symbols on the frequency axis at d=floor (12/5)=2 intervals from a lowest RE index (or a highest RE index) of a first OFDM symbol 504 that includes no DMRS after a first DMRS. Subsequently, referring to FIG. 5B, the terminal may map CSI-part1 502 from a first OFDM symbol 505 other than a DMRS 500. Finally, referring to FIG. 5C, the terminal may map CSI part 2 503 to an RE, to which CSI-part1 and the HARQ-ACK are not mapped, from the first OFDM symbol 506 including no DMRS.

When HARQ-ACK is transmitted on the PUSCH (or CG-PUSCH), the number of coded modulation symbols may be determined by Equation 12-A below.

$${Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ \} \qquad Equation 12 - A$$

Here, O_{ACK} may denote the number of bits of a payload of HARQ-ACK, and L_{ACK} may denote the number of CRC bits. More specifically, O_{ACK}≥360, otherwise, 360>O_{ACK}≥20, L_{ACK}=11, 20>O_{ACK}≥12, L_{ACK}=6, 12>O_{ACK}, and L_{ACK}=0. Kr may denote an r-th code block size of a UL-SCH, and MU_{sc}^{UCI} may denote the number of subcarriers per OFDM symbol available for UCI transmission in the PUSCH configured or scheduled by the base station. In addition, α and β_{offset}^{PUSCH} are values configured by the base station and may be determined via higher signaling or L1 signaling. More specifically, β_{offset}^{PUSCH}, i.e., a beta offset value, is a value defined to determine the number of resources when HARQ-ACK information is multiplexed with other UCI information and transmitted to the PUSCH (or CG-PUSCH). If fallback DCI (or DCI format 0_0) or non-fallback DCI (or DCI format 0_1) that has no beta_offset indicator field indicates PUSCH transmission, and the terminal configures a beta offset value configuration to be “semi-static” via higher configuration, the terminal may have one beta offset value configured via the higher configuration. In this case, beta offsets may have values as shown in Table 23, an index of a corresponding value may be indicated via higher configuration, and according to the bit number of HARQ-ACK information, indexes I_{offset,0}^{HARQ-ACK}, I_{offset,1}^{HARQ-ACK}, and I_{offset,2}^{HARQ-ACK} may have beta offset values for cases where the number of HARQ-ACK information bits is 2 or less, the number of HARQ-ACK information bits is greater than 2 and equal to or less than 11, and the number of HARQ-ACK information bits is greater than 11, respectively. In addition, it may also be possible to configure beta offset values for CSI-1 and CSI-2 in the same way. A code rate of UCI may be adjusted compared to an effective code rate of UL-SCH by the beta offset value. For example, when the beta offset value is 2 (e.g., index=1), the code rate of UCI may be configured to be transmitted at a code rate that is ½ lower than the effective code rate of UL-SCH.

TABLE 23

| I_{offset,0}^{HARQ-ACK} or I_{offset,1}^{HARQ-ACK} | |
|---|---|
| or I_{offset,2}^{HARQ-ACK} | β_{offset}^{HARQ-ACK} |
| 0 | 1.000 |
| 1 | 2.000 |
| 2 | 2.500 |
| 3 | 3.125 |
| 4 | 4.000 |
| 5 | 5.000 |
| 6 | 6.250 |
| 7 | 8.000 |
| 8 | 10.000 |
| 9 | 12.625 |
| 10 | 15.875 |
| 11 | 20.000 |
| 12 | 31.000 |
| 13 | 50.000 |
| 14 | 80.000 |
| 15 | 126.000 |
| 16 | Reserved |
| 17 | Reserved |
| 18 | Reserved |
| 19 | Reserved |
| 20 | Reserved |
| 21 | Reserved |
| 22 | Reserved |
| 23 | Reserved |
| 24 | Reserved |
| 25 | Reserved |
| 26 | Reserved |
| 27 | Reserved |
| 28 | Reserved |
| 29 | Reserved |
| 30 | Reserved |
| 31 | Reserved |

If the base station schedules PUSCH transmission for the terminal by using non-fallback DCI (or DCI format 01) and the non-fallback DCI has a beta offset indicator field, that is, the beta offset value is configured to be “dynamic” via higher configuration, the base station may configure, in the case of HARQ-ACK, beta offset values for four sets having I_{offset,0}^{HARQ-ACK}, I_{offset,1}^{HARQ-ACK}, or I_{offset,2}^{HARQ-ACK} as shown in Table 24, and configure the same for the terminal. The terminal may indicate beta offset values to be used for HARQ-ACK multiplexing by using the beta offset indicator field. Each index may be determined according to the number of HARQ-ACK information bits in the same way as the method described above. The terminal may indicate a set of I_{offset}^{CSI-1} and I_{offset}^{CSI-2} in the same method.

TABLE 24

| | (I_{offset,0}^{HARQ-ACK} or I_{offset,1}^{HARQ-ACK} |
|---|---|
| | or I_{offset,2}^{HARQ-ACK}), |
| beta_offset | (I_{offset,0}^{CSI-1} or I_{offset,0}^{CSI-2}), |
| indicator | (I_{offset,1}^{CSI-1} or I_{offset,1}^{CSI-2}) |
| “00” | 1st offset index provided by higher layers |
| “01” | 2nd offset index provided by higher layers |
| “10” | 3rd offset index provided by higher layers |
| “11” | 4th offset index provided by higher layers |

For HARQ-ACK transmission on an actual repetition of a PUSCH with repetition Type B with UL-SCH, the number (Q′_{ACK}) of coded modulation symbols per layer for HARQ-ACK transmission, denoted as Q′_{ACK}, is determined as follows:

$${Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , nominal}^{PUSCH} - 1} {M}_{sc , nominal}^{UCI} ( l ) ⌉ , {\sum }_{l = {l}_{0}}^{{N}_{symb , actual}^{PUSCH} - 1} {M}_{sc , actual}^{UCI} ( l ) \} \qquad Equation 12 - B$$

In Equation 12-B
M_{sc,nominal}^{UCI} (l) is the number of resource elements that can be used for transmission of UCI in OFDM symbol l, for l=0, 1,2, . . . . N_{symb,nominal}^{PUSCH}−1, in the PUSCH transmission assuming a nominal repetition without segmentation, and N_{symb,nominal}^{PUSCH} is the total number of OFDM symbols in a nominal repetition of the PUSCH, including all OFDM symbols used for DMRS;
For any OFDM symbol that carries DMRS of the PUSCH assuming a nominal repetition without segmentation, M_{sc,nominal}^{UCI}(l)=0;
For any OFDM symbol that does not carry DMRS of the PUSCH assuming a nominal repetition without segmentation, M_{sc,nominal}^{UCI}(l)=M_{SC}^{PUSCH}−M_{sc,nominal}^{PT-RS}(l) where M_{sc,nominal}^{PT-RS}(l) is the number of subcarriers in OFDM symbol l that carries PTRS, in the PUSCH transmission assuming a nominal repetition without segmentation;
M_{sc,nominal}^{UCI}(l) is the number of resource elements that can be used for transmission of UCI in OFDM symbol l, for l=0, 1,2, . . . . N_{symb,actual}^{PUSCH}−1, in the actual repetition of the PUSCH transmission, and N_{symb,actual}^{PUSCH} is the total number of OFDM symbols in the actual repetition of the PUSCH transmission, including all OFDM symbols used for DMRS;
For any OFDM symbol that carries DMRS of the actual repetition of the PUSCH transmission, M_{sc,nominal}^{UCI}(l)=0;
For any OFDM symbol that does not carry DMRS of the actual repetition of the PUSCH transmission, M_{sc,nominal}^{UCI}(l)=M_{SC}^{PUSCH}−M_{sc,actual}^{PT-RS} (l) where M_{sc,actual}^{PT-RS} (l) is the number of subcarriers in OFDM symbol I that carries PTRS, in the actual repetition of the PUSCH transmission; and
All the other notations in the formula are defined the same as for PUSCH not using repetition type B.

When HARQ-ACK is transmitted on a PUSCH (or CG-PUSCH), if no UL-SCH exists, the number of coded modulation symbols may be determined by Equation 12-C below.

$${Q}_{ACK}^{′} = min \{ ⌈ \frac{( {O}_{ACK} + {L}_{ACK} ) ⋅ {β}_{offset}^{PUSCH}}{R \cdot {Q}_{m}} ⌉ , ⌈ α \cdot {\sum }_{l = {l}_{0}}^{{N}_{s y mb , all}^{PUSCH} - 1} {M}_{sc}^{UCI} ( l ) ⌉ \} \qquad Equation 12 - C$$

In Equation 12-C, R is a code rate of a PUSCH, which is a value configured by the base station, and may be determined via higher-layer signaling or L1 signaling. In addition, Qₘ may denote an order of a PUSCH modulation scheme.

Based on Q′_{ACK} determined in Equation 12-A and Equation 12-B, the number E_{ACK}=N_{L}·Q′_{ACK}·Qₘ of codeword bits of ACK may be obtained.

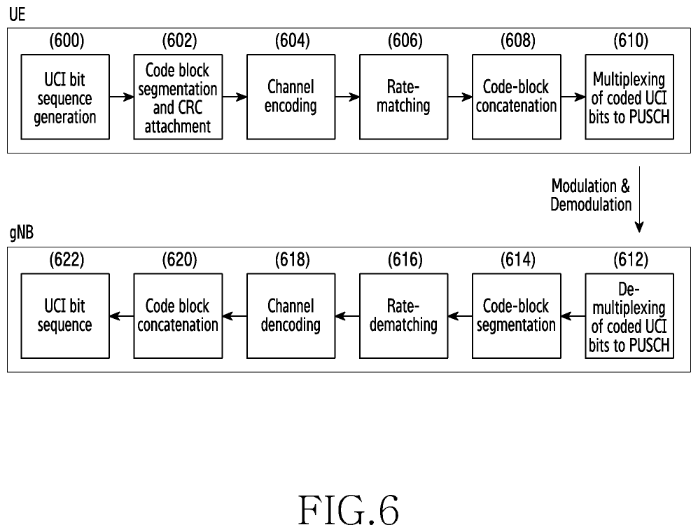

FIG. 6 is a diagram illustrating a procedure of transmitting and/or receiving UCI information between a terminal and a base station via a PUSCH according to an embodiment of the disclosure.

Referring to FIG. 6, a terminal may generate UCI information in operation 600. In operation 602, the terminal may determine a UCI information size and, if the size is 11 bits or less, CRC may not be included. On the other hand, if the size is greater than 12 bits, the terminal may additionally perform code block segmentation or CRC may be included, according to the UCI information size. In operation 604, if the UCI information size is 11 bits or less, the terminal may perform channel coding of small block lengths. On the other hand, if the size is greater than 12 bits, the terminal may perform polar coding. In operation 606, the terminal may perform rate matching according to Equation 6 to Equation 12-C according to a UCI information type so as to calculate the number of coded modulation symbols. In operation 608, the terminal may combine code blocks. In operation 610, the terminal may multiplex coded UCI bit information on a PUSCH. After the terminal transmits the modulated PUSCH to a base station, the base station may demodulate the PUSCH received from the terminal and perform demultiplexing on the coded UCI bits in the PUSCH, in operation 612. In operation 614, the base station may divide the received information into code blocks. In operation 616, the base station may perform rate dematching. In operation 618, the base station may perform decoding in a coded channel coding scheme according to the UCI information size. In operation 620, the base station may combine the decoded code blocks and acquire UCI information. The UCI information may be transmitted and/or received by being included in the PUSCH via the series of procedures described above. The flowchart described in FIG. 6 is merely an example, and at least one block among operations 600 to 622 may be omitted under a certain condition. In addition, it may be sufficiently possible to perform operation by adding blocks other than operations 600 to 622 included in the flowchart described in FIG. 6.

Subsequently, in Table 25, descriptions will be provided for a procedure of multiplexing uplink data and control information.

TABLE 25

Operation 1:
If HARQ-ACK information to be transmitted on a PUSCH has a
size of 0, 1, or 2 bits, reservation resources for latent HARQ-
ACK transmission may be determined. The reservation resources
may be determined by a frequency-first scheme from a first symbol
immediately subsequent to a symbol in which a first DMRS exists
among resources to which the PUSCH has been allocated. The
frequency-first scheme may refer to a general term for a scheme of
msequentially apping frequency resources for each symbol and then
moving to a subsequent symbol to perform mapping. In this case,
the amount of reservation resources may be calculated by assuming
that HARQ-ACK information has 2 bits.
Depending on the presence or absence of PUSCH hopping, whether
to separate, for each hop, coded bits for latent HARQ-ACK
transmission may be determined using the reservation resources.
Operation 2:
If the HARQ-ACK information to be transmitted on the PUSCH
has a size greater than 2 bits, the terminal may perform rate
tmatching. For example, the erminal may map the coded bits of the
HARQ-ACK information according to the frequency-first scheme
from the first symbol immediately subsequent to the symbol in
which the first DMRS exists among the resources to which the
PUSCH has been allocated.
Operation 2A:
When CG-UCI information to be transmitted on the PUSCH exists,
the terminal may perform rate matching. For example, the terminal
may perform frequency-first mapping for coded bits of the CG-
UCI information from the first symbol immediately subsequent to
the symbol in which the first DMRS exists among the resources
to which the PUSCH has been allocated.
Operation 3:
When CSI part 1 information to be transmitted on the PUSCH
exists, the terminal may perform rate matching. The terminal may
perform frequency-first mapping for CSI part 1 from the first
symbol in the resources to which the PUSCH has been allocated,
immediately after excluding resources to which a DMRS and CG-
UCI or HARQ-ACK or HARQ-ACK reserved allocated in
operation 1, operation 2, or operation 2A have been allocated.
Subsequently, the terminal may perform frequency-first mapping
for CSI part 2 from the first symbol in the resources to which the
PUSCH has been allocated, excluding resources to which a
DMRS and CSI part 1 or CG-UCI or HARQ-ACK allocated in
operation 2 or 2A have been allocated. CSI part 2 may be
allocated to the reserved RE allocated in operation 1.
Operation 4:
The terminal may perform data information (UL-SCH) rate
matching. The terminal may perform frequency-first mapping for
a UL-SCH to the resources to which the PUSCH has been
allocated, excluding resources to which UCI information mapped
in operation 2 and operation 3 are mapped. The UL-SCH may be
allocated to the reserved RE allocated in operation 1.
Operation 5:
If the HARQ-ACK information to be transmitted on the PUSCH
has a size no greater than 2 bits, the terminal may perform
mapping to the resource reserved in operation 1. In this case,
since calculation has been performed by assuming that HARQ-
ACK has 2 bits, actually mapped resources may be less than the
number of the reserved REs. When there is a UCI resource or
UL-SCH already mapped in operations 2 to 4 in the reserved
resource, the terminal may puncture the information and map the
HARQ-ACK information.
For the operations described above, if the number of bits (or the
number of modulated symbols) of uplink control information to
be mapped to the PUSCH is greater than the number of
bits (or REs) available for uplink control information mapping
in an OFDM symbol to be mapped, frequency axis RE interval d
between modulated symbols of the uplink control information to
be mapped may be configured so that d = 1. If the number of bits
(or the number of modulated symbols) of the uplink control
information to be mapped to the PUSCH is less than the number
of bits (or RE0s) available for uplink control information
mapping in the OFDM symbol to be mapped, frequency axis RE
interval d between modulated symbols of the uplink control
information to be mapped may be configured so that d = floor
(# of available bits on 1-OFDM symbol/# of unmapped UCI bits
at the beginning of 1-OFDM symbol).

In the procedures in Table 25 described above, the terminal may determine whether HARQ-ACK exists and perform reservation resource determination or rate matching according thereto. Then, the terminal may sequentially determine the presence or absence of CG-UCI, the presence or absence of CSI part 1, and the presence or absence of CSI part 2. The terminal may determine the presence or absence based on information indicating that a PUCCH having at least one symbol overlapping with a resource to which a PUSCH has been allocated exists or that information included in DCI for PUSCH scheduling includes specific UCI information. Then, the terminal may map data resources, and if HARQ-ACK has 2 bits or less, the terminal may map control information to pre-reserved resources.

### [PUCCH/PUSCH: Priority Level]

Hereinafter, descriptions will be provided for a scheme of terminal transmission according to priority information of a PUCCH and a PUSCH.

When one terminal concurrently supports eMBB and URLLC, the terminal may transmit eMBB data or control information via a PUSCH or PUCCH and may transmit URLLC data or control information via a PUSCH or PUCCH. Requirements for two services are different and generally a URLLC service is prioritized over an eMBB service, and therefore when at least one symbol among channels allocated with eMBB overlaps with a channel allocated with URLLC, the terminal may select at least one of the URLLC or eMBB channels to perform transmission. More specifically, priority information of the PUSCH or PUCCH may be indicated by higher-layer signaling or L1 signaling, and a priority information value may be 0 or 1. A PUCCH or PUSCH indicated by 0 may be considered for eMBB and a PUCCH or PUSCH indicated by 1 may be considered for URLLC. Of course, the disclosure is not limited to the above example.

For PUSCH, when a field capable of indicating priority information exists in DCI, a priority of the PUSCH may be determined by a value indicated by the field capable of indicating priority information. Even for a PUSCH scheduled by DCI, if there is no field capable of indicating priority in the DCI, the terminal may consider that the PUSCH has a priority value of 0. The PUSCH scheduled by the DCI may be applicable for both a case of including aperiodic CSI or semi-persistent CSI and a case of not including aperiodic CSI or semi-persistent CSI. For a configured grant PUSCH periodically transmitted and/or received without DCI, a priority may be determined by higher-layer signaling.

For PUCCH, a priority of a PUCCH for transmitting and/or receiving SR information and a priority of a PUCCH including HARQ-ACK information on semi-persistent scheduling (SPS) PDSCH may be determined by higher-layer signaling. For the PUCCH including HARQ-ACK information on the PDSCH scheduled by DCI, when there is a priority field in the DCI, the terminal may apply a priority value indicated by the priority field. If there is no priority field, the terminal may consider that the PUCCH including HARQ-ACK information has a priority value of 0. In addition, the terminal may consider that a PUCCH including semi-persistent CSI or periodic CSI always has a priority value of 0.

When resources of a PUSCH or PUCCH indicated by an L1 signal, such as DCI or higher-layer signaling overlap each other, and at least some PUCCHs or PUSCHs have different priority information, the terminal may first resolve overlapping between the PUCCH and PUSCH having a priority information value of 0. As an example, a series of procedures of adding UCI information included in a PUCCH to a PUSCH may be included. Then, when overlapping PUCCH or PUSCH resources finally determined via a low-priority PUCCH or PUSCH may be referred to as a second PUCCH or second PUSCH, and a high-priority PUCCH or PUSCH may be referred to as a first PUCCH or first PUSCH, if the second PUCCH or the second PUSCH overlaps with the first PUCCH or the first PUSCH in terms of a time resource, the terminal may cancel transmission of the second PUCCH and second PUSCH. The terminal may expect that transmission of the first PUCCH or first PUSCH starts after T_{proc,2}+d₁, that is, at least after the last symbol of PDCCH reception including DCI scheduling of the transmission. Otherwise, the terminal may consider an error case. The value proposed in Equation 2 may be used for a value of T_{proc,2}+d₁.

According to the description above, the PUCCH including HARQ-ACK information for a PDSCH including eMBB data may have a low priority value of 0, and the PUCCH including HARQ-ACK information for a PDSCH including URLLC data may have a high priority value of 1. Accordingly, when the PUCCH with the priority value of 0 and the PUCCH with the priority value of 1 overlap in terms of the time resource, the terminal may drop the PUCCH with the priority value of 0 and may transmit the PUCCH with the priority value of 1. Therefore, from the perspective of the base station, since reception of HARQ-ACK information for the PDSCH including eMBB data has failed, the base station is unable to identify whether the terminal has properly received the eMBB data, so that the eMBB data may need to be retransmitted. Accordingly, there may be a possibility that eMBB data transmission and/or reception efficiency may be deteriorated.

For convenience of description, HARQ-ACK information for a PDSCH including eMBB data may be referred to as low priority (LP) HARQ-ACK, and HARQ-ACK information for a PDSCH including URLLC data may be referred to as high priority (HP) HARQ-ACK. LP HARQ-ACK may refer to HARQ-ACK information with a priority value of 0, and HP HARQ-ACK may refer to HARQ-ACK information with a priority value of 1. Of course, the disclosure is not limited to the above example. A possible method to prevent deterioration of eMBB data transmission and/or reception efficiency may include multiplexing HP HARQ-ACK and LP HARQ-ACK concurrently on one PUCCH or PUSCH channel. Therefore, when HP HARQ-ACK and LP HARQ-ACK are multiplexed on a PUCCH or PUSCH, there may be a possibility of being multiplexed together with existing CSI part 1 and CSI part 2. If the base station or the terminal is capable of multiplexing only up to three pieces of UCI information on a PUCCH or PUSCH, a method may be required, for this purpose, to determine information to be dropped among four pieces of information and selecting the rest of the information.

Hereinafter, in an embodiment of the disclosure, descriptions will be provided for a method of multiplexing UCI information on a PUSCH in an environment where HP HARQ-ACK and LP HARQ-ACK exist. In addition, even if HP HARQ-ACK and LP HARQ-ACK are the same HARQ-ACK information, the HP HARQ-ACK and LP HARQ-ACK have different requirements, and thus there may be a need for HP HARQ-ACK to be transmitted more reliably than LP HARQ-ACK, and accordingly different encoding and rate matching methods may be applied. As an example, when the number of coded modulation symbols for HP HARQ-ACK and LP HARQ-ACK is determined in Equation 12-A, at least a different value of β_{offset}^{PUSCH} or α may be applied. In addition, when HP HARQ-ACK and LP HARQ-ACK are multiplexed on one PUSCH, Equation 12-A may be applied for HP HARQ-ACK, while the number (Q′_{LP_ACK}) of coded modulation symbols may be determined by Equation 13-A when LP HARQ-ACK is transmitted on a PUSCH (or CG-PUSCH).

$${Q}_{LP \_ ACK}^{′} = min \{ ⌈ \frac{( {O}_{LP \_ ACK} + {L}_{LP \_ ACK} ) \cdot {β}_{offset}^{PUSCH} \cdot {\sum }_{l = 0}^{{N}_{symb , all}^{PUSCH} - 1} {M}_{sc}^{U C I} ( l )}{{\sum }_{r = 0}^{{C}_{UL - SCH} - 1} {K}_{r}} ⌉ , ⌈ α \cdot {\sum }_{l = {l}_{0}}^{{N}_{s y m b , all}^{P U S C H} - 1} {M}_{sc}^{U C I} ( l ) ⌉ - {Q}_{ACK / CG - UCI}^{′} \} \qquad Equation 13 - A$$

For HARQ-ACK LP transmission on an actual repetition of a PUSCH with repetition Type B with UL-SCH, the number of coded modulation symbols per layer for HARQ-ACK LP transmission, denoted as Q′_{ACK}, is determined as follows:

$${Q}_{ACK}^{′} = min \{ ⌈ \frac{( {O}_{LP \_ ACK} + {L}_{LP \_ ACK} ) \cdot {β}_{offset}^{PUSCH} \cdot {\sum }_{l = 0}^{{N}_{symb , nominal}^{PUSCH} - 1} {M}_{s c , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} , {\sum }_{l = 0}^{{N}_{symb , actual}^{PUSCH} - 1} {M}_{sc , actual}^{UCI} ( l ) - {Q}_{ACK / CG - UCI}^{′} \}$$

In addition, when no UL-SCH exists and CSI part 1 exists, the number (Q′_{LP_ACK}) of coded modulation symbols may be determined by Equation 13-B.

$${Q}_{LP \_ ACK}^{′} = min \{ ⌈ \frac{( {O}_{LP \_ ACK} + {L}_{LP \_ ACK} ) \cdot {β}_{offset}^{PUSCH}}{R \cdot {Q}_{m}} ⌉ , ⌈ α \cdot {\sum }_{l = {l}_{0}}^{{N}_{symb , all}^{PUSCH} - 1} {M}_{s c}^{UCI} ( l ) ⌉ - {Q}_{ACK / CG - UCI}^{′} \} \qquad Equation 13 - B$$

In addition, when no UL-SCH exists and CSI part 1 exists, the number (Q′_{LP_ACK}) of coded modulation symbols may be determined by Equation 13-B.

$${Q}_{LP \_ ACK}^{′} = {\sum }_{l = {l}_{0}}^{{N}_{s y mb , all}^{PUSCH} - 1} {M}_{sc}^{UCI} ( l ) - {Q}_{ACK / CG - UCI}^{′} \qquad Equation 13 - C$$

Q′_{ACK/CG-UCI} Is a value determined based on Equation 12-A, Equation 12-B, or Equation 12-C and may denote the number of coded modulation symbols per layer for transmission of HARQ_ACK, CG-UCI, or HARQ_ACK/CG-UCI.

### [PUCCH: Type 1 HARQ-ACK Codebook]

Hereinafter, descriptions will be provided for a semi-static HARQ-ACK codebook (or Type-1 HARQ-ACK codebook).

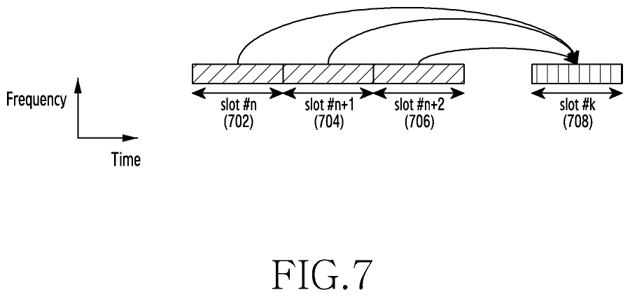

FIG. 7 is a diagram illustrating a method of configuring a semi-static HARQ-ACK codebook (or Type-1 HARQ-ACK codebook) in the 5G communication system according to an embodiment of the disclosure.

Referring to FIG. 7, in a situation where an HARQ-ACK PUCCH that a terminal may transmit within one slot is limited to one, when a configuration via semi-static HARQ-ACK codebook higher-layer signaling is received, the terminal may report HARQ-ACK information on SPS PDSCH release or PDSCH reception within an HARQ-ACK codebook in a slot indicated by a PDSCH-to-HARQ_feedback timing indicator value in DCI format 1_x. The terminal may report NACK for an HARQ-ACK information bit value within the HARQ-ACK codebook in a slot that is not indicated by a PDSCH-to-HARQ_feedback timing indicator field in DCI format 1_x. If the terminal reports only HARQ-ACK information for one PDSCH reception or one SPS PDSCH release in MAC (e.g., a set of PDSCH reception candidate cases in serving cell c) cases for candidate PDSCH reception, and when the report is scheduled by DCI format 1_0 including information indicating that a counter DACI field indicates 1 in a PCell, the terminal may determine one HARQ-ACK codebook for the PDSCH reception or the SPS PDSCH release.

Otherwise, a method of determining an HARQ-ACK codebook according to the method described below may be followed.

When a set of PDSCH reception candidates cases in serving cell c is M_{A,c}, M_{A,c} may be obtained via the following [pseudo-code 1] operations.

### [Start of Pseudo-code 1]

Operation 1: Initializing j to be 0, and M_{A,c} to be an Empty Set. Initializing k, i.e., an HARQ-ACK transmission timing index, to be 0.
Operation 2: Configuring R to be a set of respective rows in a table including information on a slot to which a PDSCH is mapped, start symbol information, and information on the length or number of symbols. If a PDSCH-capable mapping symbol indicated by each value of R is configured as an UL symbol according to DL and UL configurations configured via higher-layer signaling, a corresponding row is deleted from R.
Operation 3-1: If the terminal is able to receive up to one unicast PDSCH in one slot, and R is not an empty set, adding one unicast PDSCH to set M_{A,c}.
operation 3-2: If the terminal is able to receive more than one unicast PDSCH in one slot, counting the number of PDSCHs allocatable to different symbols in the calculated R, and adding a corresponding number of unicast PDSCHs to M_{A,c}.
Operation 4: Increasing k by 1, and starting operations again from operation 2.

### [End of Pseudo-Code 1]

Taking the aforementioned pseudo-code 1 as an example of FIG. 7, in order to perform HARQ-ACK PUCCH transmission in slot #k 708, all slot candidates capable of PDSCH-to-HARQ-ACK timing capable of indicating slot #k 708 may be considered. In FIG. 7, it may be assumed that HARQ-ACK transmission is possible in slot #k 708 by a combination of PDSCH-to-HARQ-ACK timings at which only PDSCHs scheduled in slot #n 702, slot #n+1 704, and slot #n+2 706 are possible. In addition, based on time domain resource configuration information of a PDSCH which can be scheduled in each of slots 702, 704, and 706, and information indicating whether a symbol within a slot is for downlink or uplink, the terminal may derive, for each slot, the maximum number of PDSCHs which can be scheduled. For example, when scheduling of up to two PDSCHs in slot 702, up to three PDSCHs in slot 704, and up to two PDSCHs in slot 706 are possible, the maximum number of PDSCHs included in the HARQ-ACK codebook transmitted in slot 708 may be a total of seven. This may be referred to as cardinality of the HARQ-ACK codebook.

### [PUCCH: Type 2 HARQ-ACK Codebook]

Hereinafter, a dynamic HARQ-ACK codebook (or Type-2 HARQ-ACK codebook) will be described.

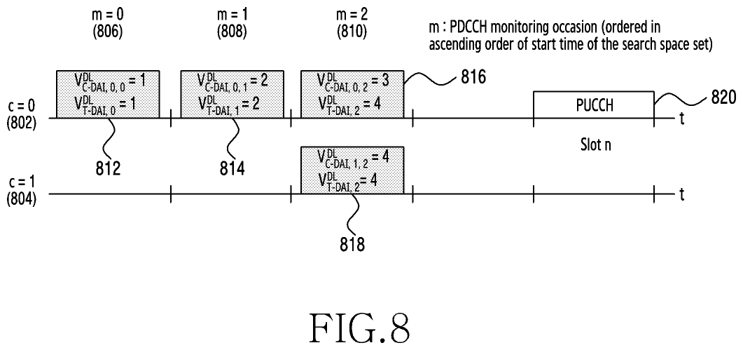

FIG. 8 is a diagram illustrating a method of configuring a dynamic HARQ-ACK codebook (or Type-2 HARQ-ACK codebook) in the 5G communication system according to an embodiment of the disclosure.

Referring to FIG. 8, based on a PDSCH-to-HARQ_feedback timing value for PUCCH transmission of HARQ-ACK information in slot n for PDSCH reception or SPS PDSCH release, and K₀ that is transmission slot position information of a PDSCH scheduled in DCI format 1_x, a terminal may transmit HARQ-ACK information transmitted within one PUCCH in slot n. Specifically, for the HARQ-ACK information transmission described above, the terminal may determine, based on a downlink assignment index (DAI) included in DCI indicating the PDSCH or SPS PDSCH release, an HARQ-ACK codebook of a PDCCH transmitted in a slot determined by K₀ and PDSCH-to-HARQ_feedback timing.

In an embodiment of the disclosure, the DAI may include a counter DAI and a total DAI. The counter DAI may be information in which HARQ-ACK information corresponding to the PDSCH scheduled in DCI format 1_x indicates a position within the HARQ-ACK codebook. Specifically, a counter DAI value in DCI format 1_x may indicate a cumulative value of SPS PDSCH release or PDSCH reception scheduled by DCI format 1_x in specific cell c. The cumulative value may be configured based on a serving cell and a PDCCH monitoring occasion in which the scheduled DCI exists. Of course, the disclosure is not limited to the above example.

In an embodiment of the disclosure, the total DAI may be a value indicating an HARQ-ACK codebook size. Specifically, a total DAI value may refer to the total number of previously scheduled PDSCH or SPS PDSCH releases, including a point in time at which the DCI has been scheduled. In addition, the total DAI may be a parameter used when HARQ-ACK information in serving cell c also includes HARQ-ACK information on a PDSCH scheduled in another cell including serving cell c in a carrier aggregation (CA) situation. In other words, there may be no total DAI parameter in a system operating with one cell. Of course, the disclosure is not limited to the above example.

An operation example for DAI may be described in FIG. 8. FIG. 8 shows, in a situation where two carriers are configured, when the terminal transmits an HARQ-ACK codebook, which is selected based on a DAI, on a PUCCH 820 in an n-th slot of carrier 0 802, a change in values of a counter DAI (C-DAI) and a total DAI (T-DAI) indicated by DCI retrieved for each PDCCH monitoring occasion configured for each carrier. First, in DCI retrieved at m=0 806, each of the C-DAI and the T-DAI may indicate a value (812) of 1. In DCI retrieved at m=1 808, each of the C-DAI and the T-DAI may indicate a value (814) of 2. In DCI retrieved in carrier 0 (c=0) 802 of m=2 810, the C-DAI may indicate a value (816) of 3. In DCI retrieved in carrier 1 (c=1) 804 of m=2 810, the C-DAI may indicate a value (818) of 4. In this case, when carriers 0 and 1 are scheduled at the same monitoring occasion, all T-DAIs may be indicated to be 4.

Referring to FIGS. 7 and 8, HARQ-ACK codebook determination may be performed in a situation where only one PUCCH including HARQ-ACK information is transmitted in one slot, and may be referred to as mode 1. As an example of a method in which one PUCCH transmission resource is determined in one slot, when PDSCHs scheduled in different DCI are multiplexed with one HARQ-ACK codebook and transmitted in the same slot, a PUCCH resource selected for HARQ-ACK transmission may be determined as a PUCCH resource indicated by a PUCCH resource field indicated by DCI via which last PDSCH scheduling has been performed. For example, a PUCCH resource indicated by a PUCCH resource field indicated in DCI scheduled before the DCI may be disregarded.

In the following description, a method and devices for HARQ-ACK codebook determination in a situation where two or more PUCCHs including HARQ-ACK information may be transmitted in one slot may be defined, and may be referred to as mode 2. The terminal may operate only in mode 1 (only one HARQ-ACK PUCCH is transmitted in one slot) or operate only in mode 2 (one or more HARQ-ACK PUCCHs are transmitted in one slot). Alternatively, for a terminal supporting both mode 1 and mode 2, it may be possible that a base station configures, via higher signaling, operation in only one mode, or mode 1 and mode 2 are determined implicitly by a DCI format, an RNTI, a DCI specific field value, scrambling, or the like. For example, a PDSCH scheduled via DCI format A and HARQ-ACK information associated with the PDSCH scheduled via DCI format A may be based on mode 1, and a PDSCH scheduled via DCI format B and HARQ-ACK information associated therewith may be based on mode 2. Of course, the disclosure is not limited to the above example.

### [PUCCH: Type 3 HARQ-ACK Codebook]

In the following, a Type-3 HARQ-ACK codebook may be described.

Unlike Type-1 and Type-2 HARQ-ACK codebooks, a Type-3 HARQ-ACK codebook may be a scheme in which the terminal reports all HARQ-ACK information for all configured serving cells, the number of HARQ processes, the number of TBs for each HARQ process, and the number of CBGs for each TB. For example, when there are 2 serving cells, 16 HARQ processes for each serving cell, 1 TB for each HARQ process, and 2 CBGs for each TB, the terminal may report a total of 64 (=2×16×1×2) HARQ-ACK information bits. In addition, according to a separate configuration, it may also be possible for the terminal to report a recently received NDI value for each HARQ-ACK information and HARQ process related to the HARQ-ACK information. Via the NDI value reported by the terminal, the base station may determine (or identify) whether a PDSCH received for each HARQ process by the terminal is determined to be initial transmission or is determined to be retransmission. When there is no separate NDI value report, if the terminal has already reported HARQ-ACK information for a specific HARQ process before the base station receives DCI for requesting of the Type-3 HARQ-ACK codebook, the terminal may map a corresponding HARQ process to NACK, otherwise, the terminal may map an HARQ-ACK information bit to the PDSCH received for each corresponding HARQ process. The number of serving cells, the number of HARQ processes, the number of TBs, and the number of CBGs may be configured respectively. When there is no separate configuration for the number of serving cells, the number of HARQ processes, the number of TBs, and the number of CBGs, the terminal may consider the number of serving cells to be 1, the number of HARQ processes to be 8, the number of TBs to be 1, and the number of CBGs to be 1. In addition, the number of HARQ processes may be different for each serving cell. In addition, the number of TBs may have a different value for each serving cell or for each BWP within a serving cell. In addition, the number of CBGs may be different for each serving cell. Of course, the disclosure is not limited to the above examples.

One of reasons that a Type-3 HARQ-ACK codebook is necessary may be because there is a case where the terminal cannot transmit a PUCCH or PUSCH including HARQ-ACK information for a PDSCH due to a channel connection failure, overlapping with another channel having a high priority, or the like. Accordingly, it may be reasonable for the base station to request reporting of only HARQ-ACK information without needing to reschedule a separate PDSCH. Therefore, the base station may schedule a Type-3 HARQ-ACK codebook and a PUCCH resource including a corresponding codebook via higher-layer signaling or L1 signal (e.g., a specific field in DCI).

If the terminal searches for a DCI format including 1 as a field value for requesting one-shot HARQ-ACK, the terminal may determine a PUCCH or PUSCH resource for multiplexing a Type-3 HARQ-ACK codebook in a specific slot indicated by the DCI format. In addition, the terminal may multiplex only the Type-3 HARQ-ACK codebook within the PUCCH or PUSCH for transmission in the corresponding slot. For example, if two PUCCHs overlap, one is a Type-1 HARQ-ACK codebook (or Type-2 HARQ-ACK codebook), and the other is a Type-3 HARQ-ACK codebook, the terminal may multiplex only the Type-3 HARQ-ACK codebook on a PUCCH or PUSCH. This is because the Type-3 HARQ-ACK codebook includes HARQ-ACK information bits for all serving cells, all HARQ process numbers, all TBs, and all CBGs configured for the terminal, and therefore information of the Type-1 HARQ-ACK codebook and Type-2 HARQ-ACK codebook may be considered to be already included in the Type-3 HARQ-ACK codebook.

However, since the Type-3 HARQ-ACK codebook includes all HARQ-ACK information bits based on information configured for all terminals, HARQ-ACK information bits for a PDSCH that is not actually scheduled may also need to be included in the codebook described above even if the HARQ-ACK information bits are mapped to NACK, and accordingly, there may be a disadvantage that an information bit size is large. Therefore, there may be a possibility that uplink transmission coverage or transmission reliability decreases as an uplink control information bit size increases. Therefore, an HARQ-ACK codebook having a size smaller than that of the Type-3 HARQ-ACK codebook may be needed. In the disclosure, this HARQ-ACK codebook may be considered to be different from the existing Type-3 HARQ codebook, and may be referred to as an enhanced Type-3 HARQ-ACK codebook (or Type-4 HARQ-ACK codebook) for convenience. However, it may be quite possible for this HARQ-ACK codebook to be replaced with another name. For example, an enhanced Type-3 HARQ-ACK codebook may be configured as follows. Of course, the disclosure is not limited to the following examples.
Type A: a subset of a total set of (configured) serving cells
Type B: a subset of a total set of (configured) HARQ process numbers
Type C: a subset of a total set of (configured) TB indexes
Type D: a subset of a total set of (configured) CBG indexes
Type E: a combination of at least two among types A to D

The enhanced Type-3 HARQ-ACK codebook may have at least one feature among types A to E, and may be configured by one or multiple sets. The enhanced Type-3 HARQ-ACK codebook may include the entire set of types A to E instead of a subset thereof. As for the meaning of multiple sets, for example, type A and type B may exist, or different subsets may exist even for type A. Based on types A to E, the enhanced Type-3 HARQ-ACK codebook may be indicated by higher-layer signaling, an L1 signal, or a combination thereof. For example, as shown in Table 26 below, a set configuration for HARQ-ACK information bits to be reported in each enhanced Type-3 HARQ-ACK codebook may be indicated via a higher-layer signal, and one of these values may be indicated by an L1 signal. As shown in Table 26, a type of enhanced Type-3 HARQ-ACK codebook configured for each index may be individually configured via higher-layer signaling. In addition, a Type-3 HARQ-ACK codebook for reporting of all HARQ-ACK information bits may be used for a specific index, such as index 3. If not separately indicated via higher-layer signaling or there is no higher-layer signaling, the Type-3 HARQ-ACK codebook may be determined to be used based on a default value (e.g., ACK or NACK states for all HARQ process numbers).

TABLE 26

| Index | Type 3 |
|---|---|
| 1 | Serving cell i, HARQ process number (#1 to #8), TB 1 |
| 2 | Serving cell i, HARQ process number (#9 to #12), TB 1 |
| 3 | Type-3 HARQ-ACK codebook |
| . . . | . . . |

The terminal may receive a value for requesting of a one-shot HARQ-ACK feedback field, and when a value indicated by index 1 according to Table 26 is received, the terminal may report a total of 8 bits of HARQ-ACK information for serving cell i, HARQ process numbers (#1 to #8), and TB 1. The terminal may receive a value for requesting of the one-shot HARQ-ACK feedback field, and when a value indicated by index 2 according to Table 26 is received, the terminal may report a total of 4 bits of HARQ-ACK information for serving cell i, HARQ process numbers (#1 to #4), and TB 1. The terminal may receive a value for requesting of the one-shot HARQ-ACK feedback field, and when a value indicated by index 3 according to Table 26 is received, the terminal may calculate a total number of HARQ-ACK bits by considering a serving cell set, a total number of HARQ processes per serving cell i, the number of TBs per HARQ process, and the number of CBGs per TB. Of course, the disclosure is not limited to the above examples. For example, Table 26 above is merely an example, and a total number of indexes may be more or fewer than this, and the range of an HARQ process value indicated by each index and/or information included in the enhanced Type-3 HARQ-ACK codebook may be different. In addition, Table 26 may be information indicated by higher-layer signaling, and a specific index may be notified via DCI. In addition, HARQ-ACK information indicated via a specific index value or a one-shot HARQ-ACK feedback field (or another L1 signal) in addition to Table 26 above may be used for the purpose of, when specific HARQ-ACK information scheduled in advance for the terminal so as to be transmitted, other than HARQ-ACK information for a specific (or all) HARQ process number, is dropped, retransmitting the specific HARQ-ACK information scheduled for the terminal so as to be transmitted. This may be referred to as dropped HARQ-ACK retransmission. Here, dropping may occur in a case of overlapping with another PUCCH or PUSCH having a higher priority than a PUCCH or PUSCH including the HARQ-ACK information. Alternatively, dropping may occur when at least one symbol of the PUCCH or PUSCH including the HARQ-ACK information has been previously indicated as a downlink symbol via higher-layer signaling. Alternatively, dropping may occur when the PUCCH or PUSCH including the HARQ-ACK information overlaps with at least part of resources indicated by DCI including uplink cancellation information for the purpose of canceling uplink transmission. When the terminal supports both dropped HARQ-ACK retransmission and (enhanced) type-3 HARQ codebook-based transmission, the terminal may report HARQ-ACK information by selecting at least one of the dropped HARQ-ACK retransmission and (enhanced) type-3 HARQ codebook-based transmission, via at least one piece of information or a combination of MCS, RV, NDI, HARQ process ID, or the like, priority information in DCI fields, a search space type in which DCI has been retrieved, or CRC of DCI and scrambled RNTI information. Alternatively, a specific index value in Table 26 may be configured as and used for dropped HARQ-ACK retransmission. Specific index selection in Table 26 may be indicated by at least one or a combination of two or more of HARQ process number, MCS, NDI, RV, frequency resource allocation information, or time resource allocation information in DCI fields. A DCI bit field size indicating the specific index of Table 26 may be determined by ┌log₂ (Nₜₒₜₐₗ^{index})┐. In this case, Nₜₒₜₐₗ^{index} may denote a total number of indexes in Table 26 configured via higher-layer signaling.

The total number N of HARQ-ACK bits may be expressed as Equation 14 below.

$$N = {\sum }_{c}^{n ( c )} {H}_{c} \times {T}_{b , c} \times {B}_{c} \qquad Equation 14$$

In Equation 14, n (c) may denote a total number of serving cells c, Hc may denote the number of HARQ processes configured in serving cell c, T_{b,c} may denote the number of TBs for each HARQ process configured in BWP b and serving cell c, and Bc may denote the number of CBGs configured in serving cell c. In addition, when the terminal searches for a DCI format having a one-shot HARQ-ACK request field value of 1, the terminal may determine a PUCCH or PUSCH resource for multiplexing a corresponding Type-3 HARQ-ACK codebook (or enhanced Type-3 HARQ-ACK codebook). In addition, the terminal may multiplex only the Type-3 HARQ-ACK codebook (or enhanced Type-3 HARQ-ACK codebook) on the PUCCH or PUSCH resource determined for transmission in a corresponding slot. If there is a PUCCH or PUSCH including SR information or CSI information, which overlaps with the PUCCH or PUSCH, the terminal may drop the SR information or CSI information without multiplexing the same. For example, the terminal may multiplex only Type-3 HARQ-ACK information, and drop other UCI of SR and CSI.

### [PUCCH Power Control]

Hereinafter, PUCCH power control may be described. Equation 15 below is an equation for determining a PUCCH transmission power.

$${P}_{PUCCH , b f , c} ( i , {q}_{u} , {q}_{d} , l ) = min \{ \begin{matrix}{P}_{CMAX , f , c} ( i ) , {P}_{{0}_{PUCCH} , b , f , c} ( {q}_{u} ) + 10 {log}_{10} ( {2}^{μ} \cdot {M}_{R B , b , f , c}^{PUCCH} ( i ) ) + \\ {PL}_{b , f , c} ( {q}_{d} ) + {Δ}_{{F}_{PUCCH}} ( i ) + {Δ}_{T F , b , f , c} ( i ) + {f}_{b , f , c} ( i , l )\end{matrix} \} [ dBm ] \qquad Equation 15$$

In Equation 15, P₀_{_{PUCCH}}_{b,f,c} (qᵤ) is a reference configuration transmission power configuration value which may have different values according to various transmission types qᵤ, and may be changed by higher-layer signaling, such as RRC or a MAC CE. If the value is changed via the MAC CE, with respect to a PDSCH on which the MAC CE has been received, when a slot in which HARQ-ACK has been transmitted is k, the terminal may determine that the changed value is applied starting from slot k+k_{offset}. k_{offset} may have different values depending on subcarrier spacings, respectively, and may have 3 ms as an example. M_{RB,b,f,c}^{PUCCH} (i) is a size of a frequency resource area to which a PUCCH is allocated. PL_{b,f,c} (q_{d}) is an estimated path attenuation value of the terminal, which the terminal may calculate based on a specific reference signal among various CSI-RSs or SS/PBCHs according to types and configuration via higher-layer signaling. The same q_{d} may be applied to repeatedly transmitted PUCCHs. The same qᵤ may be applied to repeatedly transmitted PUCCHs.

For PUCCH formats 2, 3, and 4, when a UCI size is greater than or equal to 11, a value of Δ_{TF,b,f,c} (i) in Equation 15 is determined by Equation 16 below.

$${Δ}_{T F , b , f , c} ( i ) = 10 {log}_{10} ( {K}_{1} \cdot ( {n}_{HARQ - ACK} ( i ) + {O}_{SR} ( i ) + {O}_{CSI} ( i ) ) / {N}_{RE} ( i ) ) \qquad Equation 16$$

In Equation 16, K₁ may be 6, (n_{HARQ-ACK} (i) may denote the number of HARQ-ACK bits, O_{SR} (i) may denote the number of SR bits, O_{CSI} (i) may denote the number of CSI bits, and N_{RE} (i) may denote the number of REs of PUCCH.

### [PDSCH: SPS]

Hereinafter, an SPS operation will be described. When the terminal is capable of two or more activated DL SPS operations in one cell and/or one BWP, the base station may configure two or more DL SPS configurations for one terminal. A reason for supporting two or more DL SPS configurations is that, when the terminal supports various traffic, each traffic may have different MCS, time/frequency resource allocation, or periodicity, so that it may be advantageous to configure DL SPS appropriate for each purpose.

The terminal may receive at least a part of configuration information for DL SPS via higher-layer signaling, as shown in Table 27 below.

TABLE 27

Periodicity: DL SPS transmission periodicity
nrofHARQ-Processes: the number of HARQ processes configured
for DL SPS
n1PUCCH-AN: HARQ resource configuration information for
DL SPS
mcs-Table: MCS table configuration information applied to DL SPS
sps-ConfigIndex-r16: index of SPS configured in one cell/one BWP
harq-ProcID-Offset-r16: offset value for HARQ-ACK process
number calculation
periodicityExt-r16: DL SPS transmission periodicity which is
configurable to be a different value according to a subcarrier spacing,
and periodicity is ignored when a corresponding field exists.
harq-CodebookID-r16: HARQ-ACK codebook index information for
SPS or SPS release
pdsch-AggregationFactor-r16: the number of repeated SPS PDSCH
transmissions

In the configuration information via higher-layer signaling, an SPS index may be used to indicate SPS indicated by DCI (e.g., L1 signaling) that provides SPS activation or deactivation. Specifically, in a situation where two SPSs are configured in one cell and/or one BWP via higher-layer signaling, in order for the terminal to identify activation of which SPS of the two SPSs is indicated by the DCI indicating SPS activation, index information indicating activation of which SPS is indicated may be needed in SPS higher level information. As an example, for the terminal, an HARQ process number field in the DCI indicating SPS activation or deactivation may indicate an index of a specific SPS, so that activation or deactivation may be possible. Specifically, as shown in Table 28, when DCI including CRC scrambled by CG-RNTI includes at least one of information in Table 28, and a new data indicator (NDI) field of the DCI including the CRC scrambled by CG-RNTI indicates 0, the terminal may determine that pre-activated specific SPS PDSCH release (deactivation) is indicated.

TABLE 28

| | DCI format 0_0 | DCI format 1_0 |
|---|---|---|
| HARQ process number | SPS index | SPS index |
| Redundancy version | set to “00” | set to “00” |
| Modulation and coding | set to all “1”s | set to all “1”s |
| scheme | | |
| Frequency domain resource | set to all “1”s | set to all “1”s |
| assignment | | |

In Table 28, one HARQ process number may indicate one SPS index or multiple SPS indexes. In addition to the HARQ process number field, it may be possible for another DCI field (a time resource field, a frequency resource field, MCS, RV, a PDSCH-to-HARQ timing field, or the like) to indicate one or multiple SPS index(es). Basically, one SPS may be activated or deactivated by one piece of DCI. A position of a Type-1 HARQ-ACK codebook for HARQ-ACK information on DCI indicating SPS PDSCH release may be the same as a position of a Type-1 HARQ-ACK codebook corresponding to an SPS PDSCH reception position. When a position of an HARQ-ACK codebook corresponding to candidate SPS PDSCH reception in a slot is k₁, a position of an HARQ-ACK codebook for the DCI indicating SPS PDSCH release is also k₁. Therefore, when the DCI indicating SPS PDSCH release is transmitted in slot k, the terminal may not expect to receive PDSCH scheduling corresponding to HARQ-ACK codebook position k₁ in the same slot k. Here, the terminal may consider this as an error case. In Table 28 above, DCI formats 0_0 and 1_0 are used as examples. However, Table 28 may also be applied to DCI formats 0_1 and 1_1, and may be sufficiently expanded and applied to other DCI formats 0_x and 1_x. Based on the operations described above, the terminal may receive SPS PDSCH higher-layer signaling and receive DCI indicating SPS PDSCH activation, so that at least one SPS PDSCH may be operated concurrently in one cell and/or one BWP. Then, the terminal may periodically receive an activated SPS PDSCH in one cell/one BWP, and may transmit HARQ-ACK information corresponding to the SPS PDSCH. The HARQ-ACK information corresponding to the SPS PDSCH may be determined by the terminal via slot interval information based on PDSCH-to-HARQ-ACK timing included in activated DCI information, accurate time and frequency information in a corresponding slot based on n1PUCCH-AN information included in configuration information via SPS higher-layer signaling, and PUCCH format information. If there is no PDSCH-to-HARQ-ACK timing field included in DCI information, the terminal may assume that one value pre-configured via higher-layer signaling is a default value, and determine that the default value has been applied.

Alternatively, at least one of the following DL SPS configuration information may be configured for the terminal via higher-layer signaling.
Periodicity: DL SPS transmission periodicity
nrofHARQ-Processes: the number of HARQ processes configured for DL SPS
n1PUCCH-AN: HARQ resource configuration information for DL SPS
mcs-Table: MCS table configuration information applied to DL SPS

In the disclosure, all DL SPS configuration information may be configured for each PCell or SCell, and may also be configured for each frequency bandwidth part (BWP). In addition, one or more DL SPSs may be configured for each specific cell or BWP.

The terminal may determine grant-free transmission and/or reception configuration information via reception of higher-layer signaling for DL SPS. The terminal may be able to transmit and/or receive data in a resource area configured after receiving of DCI indicating activation for DL SPS, and may not be able to transmit and/or transmit data in a resource area before receiving of the DCI indicating activation. In addition, the terminal may not be able to receive data in a resource area after receiving of DCI indicating release.

The terminal may verify a DL SPS assignment PDCCH when both of the following two conditions are satisfied for SPS scheduling activation or release.
Condition 1: a case where a CRC bit of a DCI format transmitted on the PDCCH is scrambled by CS-RNTI configured via higher-layer signaling
Condition 2: a case where an NDI field for activated transport block is configured to be 0

When some of fields constituting a DCI format transmitted on a DL SPS assignment PDCCH are the same as those shown in Table 29 or Table 30, the terminal may determine that information in the DCI format is valid activation or valid release of DL SPS. For example, when the terminal detects a DCI format including information presented in Table 29, the terminal may determine that DL SPS has been activated. As another example, when the terminal detects a DCI format including information presented in Table 30, the terminal may determine that DL SPS has been released.

When some of the fields constituting the DCI format transmitted on the DL SPS assignment PDCCH are not the same as those presented in Table 29 (special field configuration information for DL SPS activation) or Table 30 (special field configuration information for DL SPS release), the terminal may determine that CRC that does not match the DCI format has been detected.

TABLE 29

| | DCI format 1_0 | DCI format 1_1 |
|---|---|---|
| HARQ process | set to all “0”s | set to all “0”s |
| number | | |
| Redundancy | set to “00” | For the enabled transport |
| version | | block: set to “00” |

TABLE 30

| | DCI format 1_0 |
|---|---|
| HARQ process number | set to all “0”s |
| Redundancy version | set to “00” |
| Modulation and coding scheme | set to all “1”s |
| Resource block assignment | set to all “1”s |

When the terminal receives a PDSCH without receiving a PDCCH or receives a PDCCH indicating SPS PDSCH release, the terminal may generate a corresponding HARQ-ACK information bit. In addition, at least in the Rel-15 5G communication system, the terminal may not expect to transmit HARQ-ACK information(s) for reception of two or more SPS PDSCHs in one PUCCH resource. In other words, at least in the Rel-15 5G communication system, the terminal may only include HARQ-ACK information for reception of one SPS PDSCH in one PUCCH resource.

DL SPS may also be configured in a primary (P) Cell and a secondary (S Cell. For example, parameters which may be configured via DL SPS higher-layer signaling are as follows.
Periodicity: DL SPS transmission periodicity
nrofHARQ-processes: the number of HARQ processes which may be configured for DL SPS
n1PUCCH-AN: PUCCH HARQ resource for DL SPS, and the base station configures the resource to be PUCCH format 0 or 1.

Table 29 and Table 30 above may be fields available in a situation where only one DL SPS is configurable for each cell or BWP. In a situation where multiple DL SPSs are configured for each cell and BWP, a DCI field for activating (or releasing) each DL SPS resource may be different. The disclosure may provide a method for addressing such a situation.

In the disclosure, not all DCI formats described in Table 29 and Table 30 may be used to activate or release DL SPS resources, respectively. For example, DCI format 1_0 and DCI format 1_1 which are used for PDSCH scheduling may be used to activate DL SPS resources. For example, DCI format 1_0 used for PDSCH scheduling may be used to release DL SPS resources.

### [PDSCH: Scheduling Restriction]

The terminal may identify a PDSCH resource and PUCCH resource information for transmission of HARQ-ACK information for the PDSCH resource via DL DCI received from the base station. In addition, the terminal may determine PUSCH resource information via UL DCI received from the base station. If the PUCCH resource and the PUSCH resource overlap by at least one symbol in terms of a time resource, the terminal may multiplex, on the PUSCH, HARQ-ACK information included in the PUCCH and transmit the same to the base station by using only the PUSCH resource. For example, in this situation, the terminal does not perform PUCCH resource transmission. If, in the situation described above, the DL DCI is scheduled first and then the UL DCI is scheduled, the terminal may multiplex the HARQ-ACK information on the PUSCH. However, on the contrary, if the DL DCI is scheduled after the UL DCI is scheduled, the terminal does not know whether UCI information, such as HARQ-ACK information is included, when generating a TB to be transmitted in the PUSCH resource, so that a problem may occur from the perspective of terminal processing. Therefore, the terminal may not expect to receive the DL DCI after the UL DCI is scheduled, and if this case occurs, the terminal may regard the case as an error case. Alternatively, if the terminal receives, in advance, a DCI format for scheduling of PUSCH transmission in slot n, and the terminal multiplexes HARQ-ACK information in PUSCH transmission, then, the terminal may not expect to receive a DCI format associated with HARQ-ACK information reporting or PDSCH reception scheduling indicating, in slot n, a resource for PUCCH transmission including the HARQ-ACK information. Here, the terminal may consider this as an error case. However, when repeated PUSCH transmission is performed in a time division duplexing (TDD) situation, a scheduling restriction on a PUCCH including HARQ-ACK information for a PDSCH may occur.

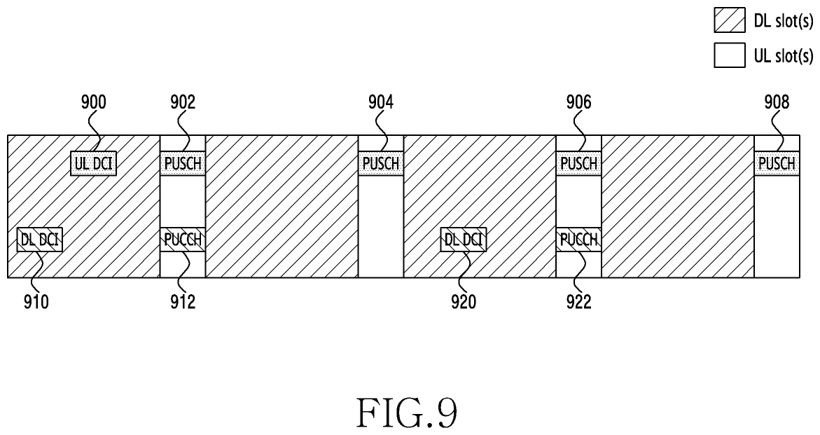

FIG. 9 is a diagram illustrating a control and data information scheduling situation according to an embodiment of the disclosure.

Referring to FIG. 9, in a situation where UL DCI 900 has scheduled four repeated PUSCH transmissions 902, 904, 906, and 908, since, with respect to a PUCCH 912 including HARQ-ACK information for DL DCI 910, the DL DCI 910 is scheduled before UL DCI 900, the terminal may multiplex the HARQ-ACK information for the DL DCI 910 on the PUSCH 902 and transmit the same. However, subsequently, with respect to a PUCCH 922 including HARQ-ACK information for DL DCI 920, since the DL DCI 920 is scheduled after the UL DCI 900, when the PUCCH 922 described in FIG. 9 is multiplexed with the PUSCH 906, the terminal considers this as an error case so that a base station may need to avoid such scheduling. Therefore, when UL resources are less than DL resources in a TDD situation, and in a situation where repeated PUSCH transmission is performed, the base station may schedule all DL DCI in advance before the UL DCI for PUSCH scheduling or may perform scheduling so that the PUCCH including HARQ-ACK information for DL DCI is transmitted after the repeated PUSCH transmission ends. The former (e.g., when scheduling all DL DCI in advance before UL DCI for PUSCH scheduling) may be a method available when the base station predicts, in advance, all traffic to be transmitted to the terminal. In the latter (e.g., when scheduling is performed so that the PUCCH including HARQ-ACK information for DL DCI is transmitted after repeated PUSCH transmission ends), since the terminal needs to receive the HARQ-ACK information for DL DCI after repeated PUSCH transmission, an unnecessary delay time may occur. Therefore, in order to address an issue that an unnecessary delay time occurs, it may be necessary, as shown in FIG. 9, to allow the DL DCI 920 for scheduling of the PUCCH 922 including HARQ-ACK information overlapping with the PUSCH 906 even after the UL DCI 900 for scheduling of the PUSCH 906. The following embodiments provide solutions to problems occurring in the situations described above.

### Embodiment 1

As shown in FIG. 9, in order to allow the DL DCI 920 for scheduling of the PUCCH 922 including HARQ-ACK information overlapping with the PUSCH 906, a separate UE capability may be reported. Accordingly, the base station may determine a terminal that allows separate UE capability reporting and a terminal that does not allow separate UE capability reporting. In addition to UE capability reporting, even if a terminal has reported a UE capability via a separate higher-layer signaling configuration of the base station, such as RRC signaling, the base station may determine whether to allow scheduling as shown in FIG. 9. Therefore, even if the terminal has reported a separate UE capability, the base station may not allow scheduling, such as the DL DCI 920 of FIG. 9, unless configured via higher-layer signaling, and when a configuration via higher-layer signaling is provided to the terminal having provided the UE capability, scheduling, such as the DL DCI 920 of FIG. 9 may be performed.

If the terminal does not report a UE capability that allows scheduling as shown in FIG. 9, or related higher-layer signaling configuration information (or when a value allowing the operation of FIG. 9 is indicated via higher-layer signaling configuration) is not received from the base station even if the terminal has reported the UE capability, in a PDCCH search area starting after a PDCCH search area in which the terminal detects a DCI format for PUSCH scheduling in a situation where a Type-1 HARQ-ACK codebook is configured via higher-layer signaling, HARQ-ACK information corresponding to PDSCH reception, SPS PDSCH release, and TCI state update detected by the terminal may be configured to be a NACK value in the HARQ-ACK codebook.

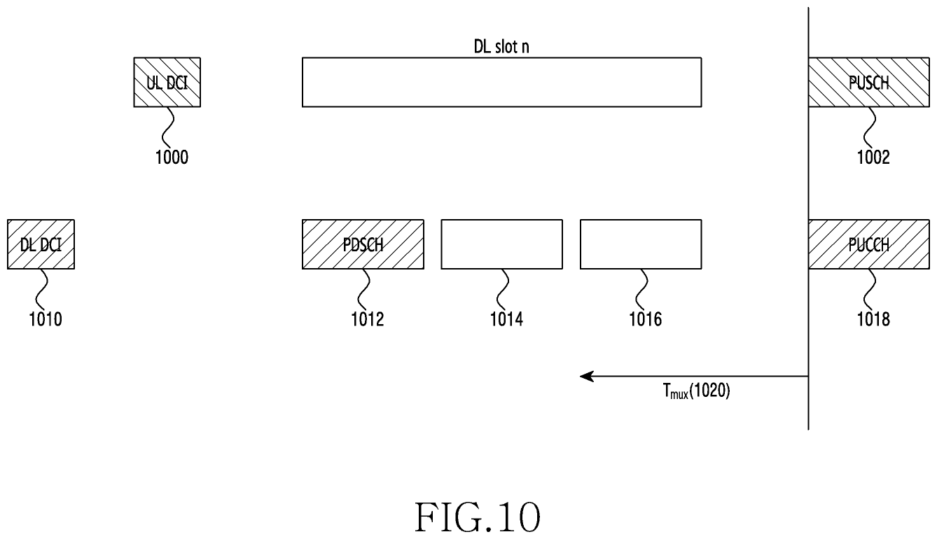

FIG. 10 is a diagram illustrating a method of determining HARQ-ACK information according to an embodiment of the disclosure.

Referring to FIG. 10, when a terminal receives UL DCI 1000 for scheduling of a PUSCH 1002, if DL DCI 1010 for scheduling of a PUCCH 1018 including HARQ-ACK information overlapping with the PUSCH 1002 is received before the UL DCI 1000, the terminal may generate a decoding result for a PDSCH 1012 scheduled by the DL DCI 1010 to be ACK or NACK, and may multiplex the generated ACK or NACK on the PUSCH 1002 and transmit the same. A Type-1 HARQ-ACK codebook may be generated based on k1 (e.g., an offset or a difference value between a slot in which a PDSCH is scheduled and a slot in which an HARQ-ACK PUCCH is scheduled) configured in advance via higher-layer signaling regardless of actual scheduling, the maximum number of PDSCHs that may be scheduled non-overlappingly in a specific DL slot, a TDD configuration, and a difference in subcarrier spacings between UL and DL. For example, in FIG. 10, up to 3 PDSCHs may be scheduled in DL slot n, and up to 3 HARQ-ACK bit sizes of the PDSCHs scheduled in the slot may be generated based on DL slot n if HARQ-ACK information may be transmitted in UL slot k in which the PUSCH 1002 or the PUCCH 1018 is transmitted. However, in FIG. 10, since there is one PDSCH, the PDSCH 1012, which is actually scheduled in DL slot n before UL DCI scheduling, the terminal may map NACK to PDSCH candidates 1014 and 1016 in which HARQ-ACK information is generated. Therefore, the HARQ-ACK information bits for DL slot n may be a total of 3 bits, and the terminal may multiplex, on the PUSCH 1002, an HARQ codebook for DL slot n with (ACK, NACK, NACK) or (NACK, NACK, NACK) and report the same to the base station. In FIG. 10, the description is limited to specific DL slot n. However, the disclosure is not limited thereto, and may be expanded and applied when multiple DL slots can be mapped to a UL slot to which the PUSCH 1002 belongs.

On the other hand, when the terminal reports a UE capability allowing scheduling as shown in FIG. 9 or reports the UE capability and receives related higher-layer signaling configuration information from the base station (or when a value allowing the operation of FIG. 9 is indicated via higher-layer signaling configuration), DL DCI for scheduling of PUCCHs including HARQ-ACK information overlapping with the PUSCH 1002 may be received even after receiving the UL DCI 1000 as shown in FIG. 10 in a situation where a Type-1 HARQ-ACK codebook has been configured via higher-layer signaling. Therefore, there may be no need to always map NACK to the PDSCH candidates 1014 and 1016 described above. Instead, the terminal may provide at least one or a combination of some of the following methods. When a combination of multiple methods is possible, the terminal may perform determination by UE capability reporting or higher-layer signaling configuration.
Method A-1: The terminal may map NACK to PDSCH candidates that are not scheduled by DL DCI or DL SPS. For example, regardless of whether UL DCI is received, the terminal may map ACK or NACK to an actually scheduled PDSCH when generating HARQ-ACK information included in the PUCCH 1018 overlapping with the PUSCH 1002, and may map NACK to other PDSCH candidates for Type-1 HARQ-ACK codebook generation.
Method A-2: The terminal may map NACK to PDSCH candidates overlapping with at least one symbol within a Tₘᵤₓ time before an earliest symbol in terms of time among the PUSCH 1002 scheduled by UL DCI and the PUCCH 1018 overlapping with the PUSCH. When describing by taking FIG. 10 as an example, since the PDSCH candidate 1016 overlaps within the Tₘᵤₓ 1020 time before the earliest symbol among PUSCH 1002 and PUCCH 1018 resources, the terminal may map NACK at least to the PDSCH candidate 1016. This may be because the terminal requires a minimum processing time to multiplex and transmit HARQ-ACK information on a PUSCH, and the later a PDSCH for HARQ-ACK information determination is received, the more difficult it is to satisfy the minimum processing time. The Tₘᵤₓ 1020 is a minimum processing time of the terminal and, specifically, may be a minimum time required to transmit all uplink control information or data information scheduled by corresponding downlink control information after the last point in time at which the downlink control information or data information is received. Therefore, when the PDSCH candidate 1016 is scheduled and when HARQ-ACK information for the PDSCH is transmitted on the PUSCH 1002, since a difference between the last symbol of the PDSCH candidate 1016 and the first symbol of the PUSCH 1002 is within the Tₘᵤₓ 1020, the terminal is unable to multiplex and transmit the HARQ-ACK information on the PUSCH due to exceeding of the minimum processing time of the terminal. Alternatively, when generating a Type-1 HARQ-ACK codebook, the terminal may generate the Type-1 HARQ-ACK codebook for DL slot n by assuming that times corresponding to Tₘᵤₓ are UL slots configured via higher-layer signaling.
Method A-3: This method is similar to method A-2, but instead of the Tₘᵤₓ 1020, a separate Tₘᵤₓ′ may be applied for the terminal to determine whether to map NACK. Tₘᵤₓ′ may be a value that is at least equal to or greater than Tₘᵤₓ, and may be reported by separate higher-layer signaling or UE capability. For example, if Tₘᵤₓ′ has a value greater than Tₘᵤₓ and is determined in advance via UE capability reporting, or is one of values reported via the UE capability and is determined by higher-layer signaling, when the PDSCH candidates having at least one symbol overlapping with the Tₘᵤₓ′ are 1014 and 1016 in FIG. 10, the terminal may map NACK to the PDSCH candidates 1014 and 1016 and may perform multiplexing on the PUSCH to perform transmission. Alternatively, when generating a Type-1 HARQ-ACK codebook, the terminal may generate the Type-1 HARQ-ACK codebook for DL slot n by assuming that times corresponding to Tₘᵤₓ′ are UL slots configured via higher-layer signaling.
Method A-4: When a slot in which the PUSCH 1002 is transmitted is referred to as slot k, the terminal may map NACK to PDSCH candidates included in slots k-1 to k-m. If m=1, only k-1 may be applicable. The method described above may be applied only after being scheduled after a point in time at which the UL DCI 1000 for scheduling of the PUSCH 1002 is transmitted and/or received. If, as shown in FIG. 10, DL slot n is a slot immediately preceding a slot in which a PUSCH is transmitted and/or received, and the DL DCI 1010 is not transmitted and/or received before the UL DCI 1000, the terminal may map NACK because there is no actual scheduling on the PDSCH 1012 including the PDSCH candidates 1014 and 1016. However, if the DL DCI 1010 is scheduled before the UL DCI 1000, and the DL DCI 1010 provides PDSCH 1012 information, the terminal may generate ACK or NACK information for the PDSCH 1012. An m value may be reported via the UE capability or determined by higher-layer signaling configuration.

When the terminal does not report the UE capability allowing scheduling as shown in FIG. 9 or does not receive related higher-layer signaling configuration information from the base station even if the UE capability is reported (or when a value that does not allow the operation of FIG. 9 is received via higher-layer signaling configuration), since there is one PDSCH, the PDSCH 1012, which is actually scheduled in DL slot n before UL DCI scheduling in FIG. 10, the terminal may map NACK to the PDSCH candidates 1014 and 1016 where has information is generated. Therefore, the HARQ-ACK information bits for DL slot n may be a total of 3 bits, and the terminal may multiplex, on the PUSCH 1002, an HARQ codebook for DL slot n with (ACK, NACK, NACK) or (NACK, NACK, NACK) and report the same. In FIG. 10, the description is limited to specific DL slot n. However, the disclosure is not limited thereto, and may be expanded and applied when multiple DL slots can be mapped to a UL slot to which the PUSCH 1002 belongs.

### Embodiment 2

A Type-2 HARQ-ACK codebook corresponds to a method of indicating an HARQ-ACK information size in advance by using DL DCI or UL DCI. Specifically, it is possible to indicate an HARQ-ACK codebook size via a DAI of the DL DCI or a DAI value of the UL DCI. For example, when the DAI of the UL DCI indicates 2 in a situation where the UL DCI indicates repetition transmission of the four PUSCHs 902, 904, 906, and 908 in FIG. 9, at least one of the following methods may be applied to HARQ-ACK sizes included in repeatedly transmitted PUSCHs.
Method B-1: HARQ-ACK sizes that may be multiplexed according to repeatedly transmitted PUSCHs may be different from each other. Specifically, an HARQ-ACK size may be N bits having a value of mod (N/4)=2. For example, an HARQ-ACK bit size multiplexed on the PUSCH 902 may be 2 bits, an HARQ-ACK bit size multiplexed on the PUSCH 904 may be 6 bits, and an HARQ-ACK bit size multiplexed on the PUSCH 906 may be 10 bits.
Method B-2: HARQ-ACK sizes that may be multiplexed according to repeatedly transmitted PUSCHs may need to be the same. For example, if HARQ-ACK information is multiplexed on the PUSCHs 904, 906, and 908, and the HARQ-ACK bit size multiplexed on PUSCH 902 is 2 bits, the HARQ-ACK bit sizes for the remaining PUSCHs 904, 906, and 908 may also be 2 bits. For example, the HARQ-ACK bit sizes of the PUSCHs 904, 906, and 908 may follow the bit size determined for the first PUSCH 902.
Method B-3: Regardless of the HARQ-ACK bit size multiplexed on the first PUSCH 902, the HARQ-ACK bit sizes multiplexed on the other PUSCHs 904, 906, and 908 may correspond to a method of obtaining an N=2 value which is a smallest natural number in mod (N/4)=2. For example, even if the HARQ-ACK bit size multiplexed on the first PUSCH 902 is 6 bits, the HARQ-ACK bit sizes multiplexed on the other PUSCHs 904, 906, and 908 may be 2 bits.

In the methods described above, cases where the DAI value of the UL DCI is 2 have been assumed, but the methods may also be applied to other values. A combination of at least one or some of the methods described above may be applied. For example, when the terminal does not report the UE capability allowing scheduling as shown in FIG. 9 or does not receive related higher-layer signaling configuration information from the base station even if the UE capability has been reported, method B-1 may be applied. In addition, for example, when the terminal reports the UE capability allowing scheduling as shown in FIG. 9 and receives related higher-layer signaling configuration information from the base station (or when a value allowing the operation of FIG. 9 is indicated via higher-layer signaling configuration), method B-2 or method B-3 may also be applied.

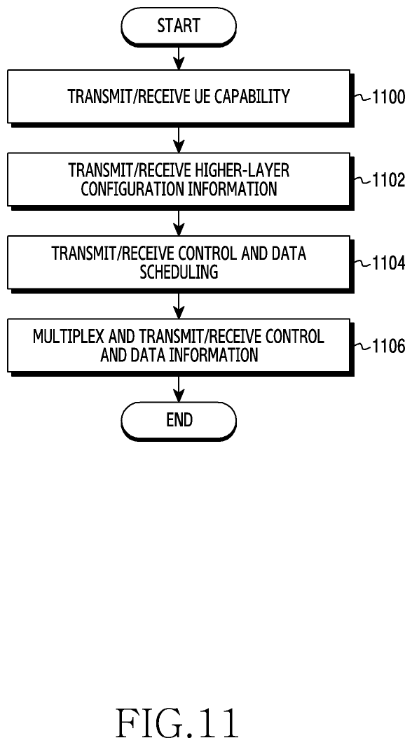

FIG. 11 is a flowchart illustrating a method of scheduling control and data information by a terminal according to an embodiment of the disclosure.

Referring to FIG. 11, when a terminal allows scheduling as shown in FIG. 9, in operation 1100, the terminal may report a UE capability to a base station, and the base station may receive the same. Then, in operation 1102, the base station may provide, via separate higher-layer signaling configuration information, information including whether scheduling as shown in FIG. 9 is allowed, and the terminal may receive the information including whether scheduling is allowed. The base station may transmit information on control and data information scheduling to the terminal via a PDCCH, and in operation 1104, the terminal may receive the information on control and data information scheduling from the base station. According to the UE capability and the higher-layer signaling configuration information, in operation 1106, the terminal may multiplex control and data information, based on information scheduled from the base station, and transmit the multiplexed control and data information to the base station. In this case, the terminal may operate based on embodiment 1 and embodiment 2 described above.

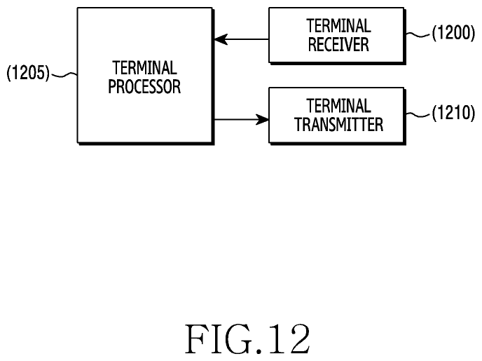

FIG. 12 illustrates a structure of a UE in a wireless communication system according to an embodiment of the disclosure.

Referring to FIG. 12, the UE may include a transceiver, which refers to a UE receiver 1200 and a UE transmitter 1210 as a whole, memory (not illustrated), and a UE processor 1205 (or UE controller or processor). The UE receiver 1200 and the UE transmitter 1210, the memory, and the UE processor 1205 may operate according to the above-described communication methods of the UE. Components of the UE are not limited to the above-described example. For example, the UE may include a larger or smaller number of components than the above-described components. Furthermore, the transceiver, the memory, and the processor may be implemented as a single chip. The UE receiver 1200 and the UE transmitter 1210 may transmit/receive signals with the base station. The signals may include control information and data. To this end, the UE receiver 1200 and the UE transmitter 1210 may include an RF transmitter configured to up-convert and amplify the frequency of transmitted signals, an RF receiver configured to low-noise-amplify received signals and down-convert the frequency thereof, and the like. This is only an embodiment of the UE receiver 1200 and the UE transmitter 1210, and the components of the UE receiver 1200 and the UE transmitter 1210 are not limited to the RF transmitter and the RF receiver.

In addition, the UE receiver 1200 and the UE transmitter 1210 may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media, such as a ROM, a RAM, a hard disk, a CD-ROM, and a DVD, or a combination of storage media. In addition, the UE may include multiple memories. Furthermore, according to an embodiment of the disclosure, the memory may store programs for executing the above-described control information and data transmission/reception methods.

In addition, the UE processor 1205 may control a series of processes such that the UE can operate according to the above-described embodiments. For example, the UE processor 1205 may control components of the UE so as to receive DCI configured in two layers such that multiple PDSCHs are received simultaneously. The UE may include multiple processors, and the UE processors 1205 may perform the UE's component control operations by executing programs stored in the memory. The UE processor 1205 may control the UE components to perform the embodiments of the disclosure by executing the programs stored in the memory. In addition, the UE processor 1205 may be an application processor (AP), a communication processor (CP), a circuit, an application-specific circuit, or at least one processor.

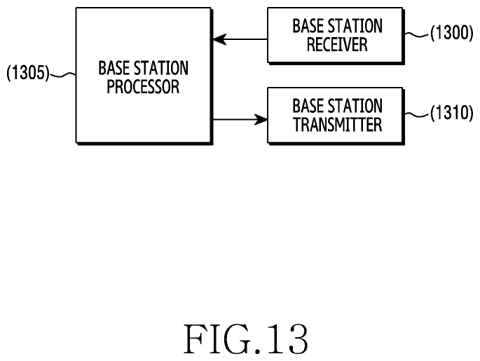

FIG. 13 illustrates a structure of a base station in a wireless communication system according to an embodiment of the disclosure.

Referring to FIG. 13, the base station may include a transceiver, which refers to a base station receiver 1300 and a base station transmitter 1310 as a whole, memory (not illustrated), and a base station processor 1305 (or base station controller or processor). The base station receiver 1300 and the base station transmitter 1310, the memory, and the base station processor 1305 may operate according to the above-described communication methods of the base station. Components of the base station are not limited to the above-described example. For example, the base station may include a larger or smaller number of components than the above-described components. Furthermore, the transceiver, the memory, and the processor may be implemented as a single chip.

The base station receiver 1300 and the base station transmitter 1310 may transmit/receive signals with the UE. The signals may include control information and data. To this end, the base station receiver 1300 and the base station transmitter 1310 may include an RF transmitter configured to up-convert and amplify the frequency of transmitted signals, an RF receiver configured to low-noise-amplify received signals and down-convert the frequency thereof, and the like. This is only an embodiment of the base station receiver 1300 and the base station transmitter 1310, and the components of the base station receiver 1300 and the base station transmitter 1310 are not limited to the RF transmitter and the RF receiver.

In addition, the base station receiver 1300 and the base station transmitter 1310 may receive signals through a radio channel, output the same to the base station processor 1305, and transmit signals output from the base station processor 1305 through the radio channel.

The memory may store programs and data necessary for operations of the base station. In addition, the memory may store control information or data included in signals transmitted/received by the base station. The memory may include storage media, such as ROM, RAM, a hard disk, a CD-ROM, and a DVD, or a combination of storage media. In addition, the base station may include multiple memories. Furthermore, according to an embodiment of the disclosure, the memory may store programs for executing the above-described control information and data transmission/reception methods.

The base station processor 1305 may control a series of processes such that the base station can operate according to the above-described embodiments of the disclosure. For example, the processor may control components of the base station so as to configure DCI configured in two layers including allocation information regarding multiple PDSCHs and to transmit the same. The base station may include multiple base station processors 1305, and the base station processors 1305 may perform the base station component control operations by executing programs stored in the memory. The base station processor 1305 may control the UE components to perform the embodiments of the disclosure by executing the programs stored in the memory. In addition, the base station processor 1305 may be an application processor (AP), a communication processor (CP), a circuit, an application-specific circuit, or at least one processor.

It should be noted that the above-described configuration diagrams, illustrative diagrams of control/data signal transmission methods, illustrative diagrams of operation procedures, and structural diagrams as illustrated in FIGS. 1 to 4, 5A, 5B, 5C, and 6 to 13 are not intended to limit the scope of protection of the disclosure. For example, all the constituent elements, entities, or operation steps shown and described in FIGS. 1 to 4, 5A, 5B, 5C, and 6 to 13 should not be construed as being essential elements for the implementation of the disclosure, and even when including only some of the elements, the disclosure may be implemented without impairing the true of the disclosure.

The methods according to the embodiments described in the claims or the specification of the disclosure may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described in the claims or the specification of the disclosure.

Such a program (software module, software) may be stored to random access memory, non-volatile memory including flash memory, read only memory (ROM), electrically erasable programmable ROM (EEPROM), a magnetic disc storage device, a compact disc (CD)-ROM, a digital versatile disc (DVD) or other optical storage device, and a magnetic cassette. Alternatively, it may be stored to memory combining part or all of those recording media. A plurality of memories may be included.

In addition, the program may be stored in an attachable storage device accessible via a communication network, such as internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment of the disclosure.

In the specific embodiments of the disclosure, the components included in the disclosure are expressed in a singular or plural form. However, the singular or plural expression is appropriately selected according to a proposed situation for the convenience of explanation, the disclosure is not limited to a single component or a plurality of components, the components expressed in the plural form may be configured as a single component, and the components expressed in the singular form may be configured as a plurality of components.

Meanwhile, while the specific embodiment has been described in the explanations of the disclosure, it will be noted that various changes may be made therein without departing from the scope of the disclosure. Therefore, the scope of the disclosure is not limited and defined by the described embodiment and is defined not only the scope of the claims as below but also their equivalents.

The embodiments of the disclosure described and shown in the specification and the drawings are merely specific examples that have been presented to easily explain the technical contents of the disclosure and help understanding of the disclosure, and are not intended to limit the scope of the disclosure. For example, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a terminal. As an example, a part of embodiment 1 of the disclosure may be combined with a part of embodiment 2 to operate a base station and a terminal. Furthermore, although the above embodiments have been presented based on the FDD LTE system, other variants based on the technical idea of the above embodiments may also be implemented in other systems, such as TDD LTE, 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, a high layer signaling including information enabling a multiplexing of a first hybrid automatic repeat request-acknowledgement (HARQ-ACK) information;
receiving, from the base station, first downlink control information (DCI) scheduling physical uplink shared channel (PUSCH) repetitions;
receiving, from the base station after the first DCI, second DCI indicating a physical uplink control channel (PUCCH); and
transmitting, to the base station, the first HARQ-ACK information by multiplexing the first HARQ-ACK information in at least one PUSCH repetition other than a first PUSCH repetition among the PUSCH repetitions.

2. The method of claim 1, further comprising:
transmitting, to the base station, UE capability information including information indicating whether the UE supports the multiplexing.

3. The method of claim 1, wherein the first HARQ-ACK information is for a physical downlink shared channel (PDSCH) scheduled by the second DCI.

4. The method of claim 1, further comprising:
transmitting, to the base station, a second HARQ-ACK information including a negative acknowledgment (NACK) value.

5. The method of claim 4, wherein the second HARQ-ACK information includes the NACK value, in case that a condition associated with a processing time for the multiplexing is not satisfied.

6. A method performed by a base station in a wireless communication system, the method comprising:
transmitting, to a user equipment (UE), a high layer signaling including information enabling a multiplexing of a first hybrid automatic repeat request-acknowledgement (HARQ-ACK) information;
transmitting, to the UE, first downlink control information (DCI) scheduling physical uplink shared channel (PUSCH) repetitions;
transmitting, to the UE after the first DCI, second DCI indicating a physical uplink control channel (PUCCH); and
receiving, from the UE, the first HARQ-ACK information, wherein the first HARQ-ACK information is multiplexed in at least one PUSCH repetition other than a first PUSCH repetition among the PUSCH repetitions.

7. The method of claim 6, further comprising:
receiving, from the UE, UE capability information including information indicating whether the UE supports the multiplexing.

8. The method of claim 6, wherein the first HARQ-ACK information is for a physical downlink shared channel (PDSCH) scheduled by the second DCI.

9. The method of claim 6, further comprising:
receiving, from the UE, a second HARQ-ACK information including a negative acknowledgment (NACK) value.

10. The method of claim 9, wherein the second HARQ-ACK information includes the NACK value, in case that a condition associated with a processing time for the multiplexing is not satisfied.

11. A user equipment (UE) in a wireless communication system, the UE comprising:
a transceiver; and
at least one processor coupled with the transceiver and configured to:
receive, from a base station, a high layer signaling including information enabling a multiplexing of a first hybrid automatic repeat request-acknowledgement (HARQ-ACK) information,
receive, from the base station, first downlink control information (DCI) scheduling physical uplink shared channel (PUSCH) repetitions,
receive, from the base station after the first DCI, second DCI indicating a physical uplink control channel (PUCCH), and
transmit, to the base station, the first HARQ-ACK information by multiplexing the first HARQ-ACK information in at least one PUSCH repetition other than a first PUSCH repetition among the PUSCH repetitions.

12. The UE of claim 11, wherein the at least one processor is further configured to:
transmit, to the base station, UE capability information including information indicating whether the UE supports the multiplexing.

13. The UE of claim 11, wherein the first HARQ-ACK information is for a physical downlink shared channel (PDSCH) scheduled by the second DCI.

14. The UE of claim 11, wherein the at least one processor is further configured to:
transmit, to the base station, a second HARQ-ACK information including a negative acknowledgment (NACK) value.

15. The UE of claim 14, wherein the second HARQ-ACK information includes the NACK value, in case that a condition associated with a processing time for the multiplexing is not satisfied.

16. A base station in a wireless communication system, the base station comprising:
a transceiver; and
at least one processor coupled with the transceiver and configured to:
transmit, to a user equipment (UE), a high layer signaling including information enabling a multiplexing of a first hybrid automatic repeat request-acknowledgement (HARQ-ACK) information,
transmit, to the UE, first downlink control information (DCI) scheduling physical uplink shared channel (PUSCH) repetitions,
transmit, to the UE after the first DCI, second DCI indicating a physical uplink control channel (PUCCH), and
receive, from the UE, the first HARQ-ACK information, wherein the first HARQ-ACK information is multiplexed in at least one PUSCH repetition other than a first PUSCH repetition among the PUSCH repetitions.

17. The base station of claim 16, wherein the at least one processor is further configured to:
receive, from the UE, UE capability information including information indicating whether the UE supports the multiplexing.

18. The base station of claim 16, wherein the first HARQ-ACK information is for a physical downlink shared channel (PDSCH) scheduled by the second DCI.

19. The base station of claim 16, wherein the at least one processor is further configured to:
receive, from the UE, a second HARQ-ACK information including a negative acknowledgment (NACK) value.

20. The base station of claim 19, wherein the second HARQ-ACK information includes the NACK value, in case that a condition associated with a processing time for the multiplexing is not satisfied.
